(19) United States
(12) Patent Application Publication
(10) Pub. No.: US 2021/0133802 A1
(43) Pub. Date: May 6, 2021

(54) METHODS AND SYSTEMS FOR BILLBOARDS IN DATA MANAGEMENT PLATFORM FOR CONTACT CENTER

(71) Applicant: Talkdesk, Inc., San Francisco, CA (US)

(72) Inventor: Jafar Adibi, Los Angeles, CA (US)

(21) Appl. No.: 16/668,442

(22) Filed: Oct. 30, 2019

(51) Int. Cl. G06Q 30/02; G06F 16/23

(52) U.S. Cl. CPC G06Q 30/0246; G06Q 30/0276; G06F 16/2379

(57) ABSTRACT

A method for billboards in a data management platform (DMP) includes: receiving an indication from a user during an interaction between the user and an agent that the user would like to hear an offer; determining at least one offer to play to the customer; determining statistics regarding at least one of the characteristics, features, or aspects of the at least one offer that customers have indicated as liking or have acted on; determining measurements for KPIs regarding at least one of the interaction or the at least one offer, and other metrics; generating one or more billboards using the statistics and the measurements; and announcing the one or more billboards to one or more of clients, contact centers, or customers. The billboards comprise at least one of the characteristics, features, or aspects of the at least one offer that customers have indicated as liking or have acted on.

### BACKGROUND

A data management platform (DMP) is a technology platform used for collecting and managing data, mainly for digital marketing purposes. A DMP acts as a unifying platform to collect, organize, and activate first-, second-, and third-party audience data from any source, including online, offline, mobile, and beyond. A DMP can be used to generate audience segments, which are used to target specific users in online advertising campaigns. The DMP may use big data and artificial intelligence algorithms to process big data sets about users from various sources.

However, current DMPs neither efficiently nor effectively sort and convert raw data into a usable form for marketers or other clients use in areas such as targeted advertising, personalization, and content customization.

### SUMMARY

A data management platform (DMP) integrates data by anonymously integrating data streams from multiple data sources. The DMP unifies audiences by consolidating and unifying audiences for cross channel and contextual targeting. The DMP provides analytics by providing audience insights. The DMP also provides activation by creating audiences and activates against specific segments, cross channel/cross device, and on site. The DMP provides insights, such as audience intelligence and segmentation. By integrating all of the data sets, richer audience profiles can be created. This allows far greater insights that can be leveraged to enhance the web experience, fuel strategic direction, and build audience segments for targeting. Insights can provide dashboard access for a client's own data, and/or comprehensive data based on multiple clients' data.

An intelligent database is a comprehensive database of data pertaining to agents, users, interactions, and clients. It is built from every interaction. Unique data can be extracted, inferred, and/or correlated from the intelligent database. After the intelligent database is built, hidden patterns may be determined and extracted for the client(s). The intelligent database comprises a comprehensive repository of every single interaction with associated entities and features, and enables real-time analytics and data-driven business decisions.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for a data management platform (DMP);

FIG. 2 is an illustration of an exemplary marketing environment using a DMP;

FIG. 3 is an operational flow of an implementation of a method that may be performed by a DMP;

FIG. 4 is an illustration of an exemplary environment for an intelligent database;

FIG. 5 is an operational flow of an implementation of a method that may be performed using an intelligent database;

FIG. 6 is a diagram of an example DMP;

FIG. 7 is a diagram of an example intelligent database;

FIG. 8 is an operational flow of an implementation of a method of extracting information for use with a DMP;

FIG. 9 is a diagram illustrating clusters;

FIG. 10 is another diagram illustrating clusters;

FIG. 11 is a diagram illustrating a tree with groups;

FIG. 12 is a diagram illustrating a graph with clusters;

FIG. 13 is an illustration of example input and output of a DMP;

FIG. 14 is a diagram of example types of data provided by a DMP;

FIG. 15 is an illustration of various types of normalized data;

FIG. 16 is an illustration of the use of segmentation and rules to generate industry based rules;

FIG. 17 is a diagram useful for illustrating segmentation;

FIG. 18 is a diagram useful for illustrating fingerprinting;

FIG. 19 illustrates an example of data extracted from a conversation that is used in segmentation;

FIG. 20 is an operational flow of an implementation of a method of segmenting;

FIG. 21 is an operational flow of an implementation of a method of segmenting and generating a customer DNA;

FIG. 22 is an illustration useful for describing customer DNA;

FIG. 23 is an illustration useful for describing customer DNA;

FIG. 24 is an operational flow of an implementation of a method of generating and providing output to a client;

FIG. 25 is an operational flow of an implementation of a method of generating and providing output to clients;

FIG. 26 is an illustration showing PII (personally identifiable information) data being input and provided as non-PII data as output;

FIG. 27 illustrates the use of a mapper;

FIG. 28 illustrates the use of a hash function;

FIG. 29 is an operational flow of an implementation of a method of generating and providing a billboard;

FIG. 30 is an operational flow of another implementation of a method of generating and providing a billboard;

FIG. 31 is an illustration of another exemplary marketing environment using a DMP;

FIG. 32 is an illustration of another exemplary marketing environment using a DMP;

FIG. 33 is an operational flow of an implementation of a method of chat advertisement;

FIG. 34 is an operational flow of an implementation of a method of call advertisement;

FIG. 35 is an operational flow of an implementation of a method of proactive marketing;

FIG. 36 is an operational flow of an implementation of a method of predictive marketing; and

FIG. 37 shows an exemplary computing environment in which example embodiments and aspects may be implemented.

### DETAILED DESCRIPTION

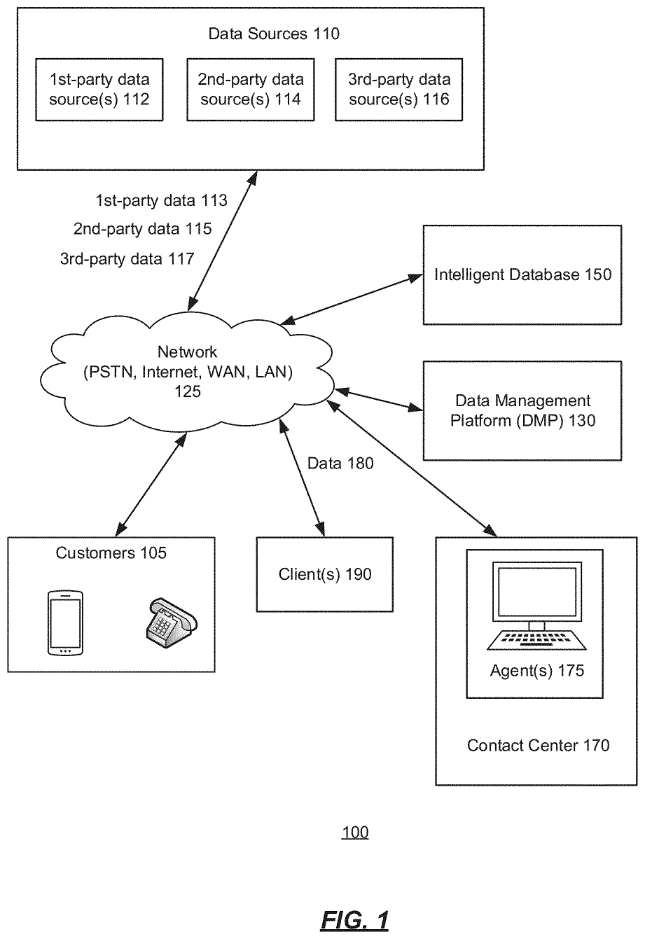

FIG. 1 is an illustration of an exemplary environment 100 for a data management platform (DMP) 140. The environment 100 may include customers 105, data sources 110, the DMP 130, an intelligent database 150, a contact center 170 having one or more agents 175, and one or more clients 190. The customers 105, the data sources 110, the DMP 130, the intelligent database 150, the contact center 170, and the client(s) 190 may be in communication through a network 125. The network 125 may be a variety of network types including the public switched telephone network (PSTN), a cellular telephone network, a packet switched network (e.g., the Internet), a wide area network (WAN), and a local area network (LAN). There is no limit to the number of data sources 110, DMPs 130, intelligent databases 150, customers 105, contact centers 170, and clients 190 that may be supported.

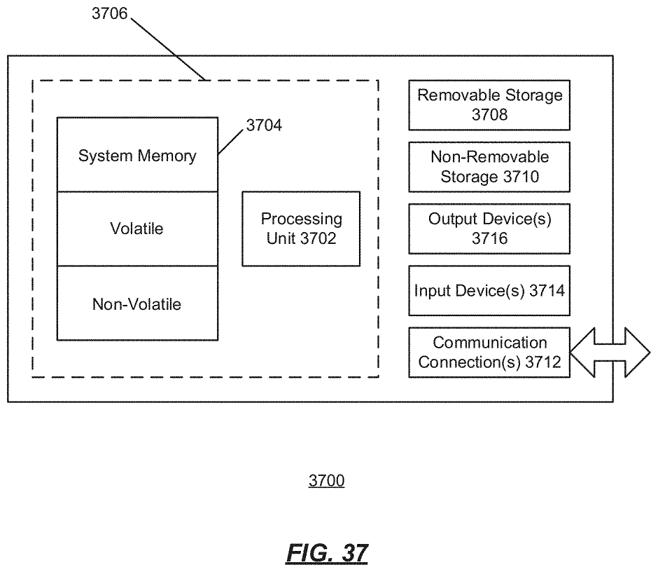

The DMP 130 may be implemented using a variety of computing devices such as smartphones, desktop computers, laptop computers, tablets, set top boxes, vehicle navigation systems, and video game consoles. Other types of computing devices may be supported. A suitable computing device is illustrated in FIG. 37 as the computing device 3700.

The DMP 130 is a unified and centralized technology platform used for collecting, organizing, and activating large sets of data from disparate data sources 110, including first-party data sources 112, second-party data sources 114, and third-party data source 116. In an implementation, the DMP 130 comprises a data warehouse, or software, that ingests, sorts, and stores massive amounts of data 113, 115, 117, taken from a wide range of first-party, second-party, and third-party data sources 112, 114, 116, respectively, that can be analyzed and exported. Audience data points (including those of the customers 105) are stored by cookies or IDs in order to generate audience segments for subsequent targeting.

The first-party data 113 is data and collected and owned by an organization maintaining the DMP 130. It includes PH (personally identifiable information) such as names, addresses, telephone numbers, email addresses, call features, interaction features, language, etc., and may be collected from sales, web, marketing automation platforms, CRM (customer relationship management) technology, offline, or other sources. PH is data that may identify a specific individual. Any data that can be used to distinguish one person from another and can be used for de-anonymizing anonymous data can be considered PH.

The second-party data 115 is data owned by a partner but shared with an organization, such as the organization maintaining the DMP 130. Data may be traded between partners. Second-party data 115 may be received from direct partnerships with other websites, companies, advertisers, etc., and/or when clients bring their own data. Second-party data 115 may be viewed in some cases as first-party data that has been been collected directly by someone else.

The third-party data 117 is data generated and owned by other parties and/or vendors. It is anonymous data, as there is no PII contained therein.

The intelligent database 150 is a comprehensive database of data pertaining to agents, users, interactions, and clients. It is built from every interaction. Unique data can be extracted, inferred, and/or correlated from the intelligent database 150. In this manner, it is possible to extract, enrich, and infer data points from every single interaction and put in one or more well-defined standard databases. In some implementations, data is collected, integrated, and analyzed in every single point of interaction, and is used to provide a comprehensive view regarding customers' behaviors and opinions. Examples of such data includes customer data, conversation data, and interaction data. An example of extraction is finding the most relevant conversation from the past month (or predetermined time period) and providing the conversation to an agent, customer, client, database, or other user, storage, or output device.

Customer data includes customers demographics such as gender, age category from the voice or the type of the spoken word, and psychographics such as the personality type of the caller, potential interest to brands, time of the call, and association of the time of the call and profession, etc.

Conversation data includes information that can be extracted from the speech analysis such as the tone, agony, pain, speed, interruption, compliance, etc.

Interaction data includes any information extracted from metadata such as waiting time, estimated waiting time, agent data, agent reaction, etc.

After the intelligent database 150 is built, hidden patterns may be determined and extracted for the client(s) 190. The intelligent database 150 comprises a comprehensive repository of every single interaction with associated entities and features, and enables real-time analytics and data-driven business decisions.

In an implementation, the intelligent database 150 is open to the client(s) 190, and each client can access data in the intelligent database 150 and use that data in conjunction with their own processed data.

The customers 105 may be an audience of consumers that may interact with agent(s) 175 of the contact center 170. The customers 105 may be users of products and/or services associated with the contact center 170, and may interact with the agent(s) 175 of the contact center 170 to discuss the products and/or services or an entity associated with the contact center 170 (e.g., provide positive or negative feedback about the products and/or services and/or entity, ask questions, provide requests, etc.).

The contact center 170 is a centralized office for providing omnichannel support for the products and/or services and responding to inquiries from the customers 105. The support may be provided by the agents 175, who may be human agents and/or virtual agents (i.e., virtual assistants). The contact center 170 is able to provide service to customers on many channels (e.g., that the entity being supported is present on). In some implementations, the contact center 170 may be, or a comprise, a call center directed to providing telephone support for the products and/or services and responding to inquiries from the customers 105.

Each of the client(s) 190 may be a client of the company providing the DMP 130 and the intelligent database 150. As described further herein, the DMP 130, alone or in conjunction with the intelligent database 150 depending on the implementation, may provide data 180, in various forms, to the client(s) 190 for various marketing and ad campaigns, for example, or for other uses, such as further analysis by the client(s) 190. The data 180 may also be provided to the contact center 170 (e.g., for analysis, for use by the agent(s) 175, etc.). The DMP 130 may provide data to the intelligent database 150, and vice versa, as described further herein.

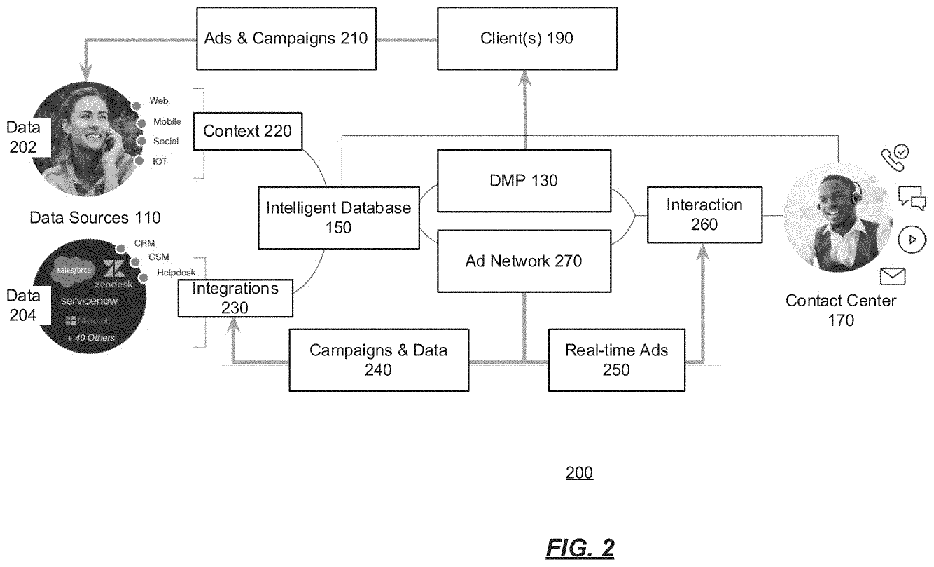

FIG. 2 is an illustration of an exemplary marketing environment 200 using a DMP 130. The data sources 110 generate and/or provide data, which are shown here as comprising, for example, customer data 202 based on web, mobile, social, and internet of things (IoT) data, conversations, postings, chats, etc. as well as customer data 204 based on customer relationship management (CRM) data, customer service management (CSM), and helpdesk relationships, interactions, etc.

The data 202 is used to provide context 220 to the intelligent database 150. The data 204 is used to provide integrations 230 to the intelligent database 150. The intelligent database 150 stores the data 202 and 204, may process the data 202 and 204, and may provide the data 202 and 204, as well as the context 220 and integrations 230 and other data described further herein, to the DMP 130.

The intelligent database 150 may provide data, including the data 202 and 204, as well as the context 220 and integrations 230 and other data described further herein, to an ad network 270. The ad network 270 may be used to generate and provide real-time ads 250 and other information (e.g., marketing information) to the contact center 170 via an interaction 260 with the contact center 170. The ad network 270 may also generate campaigns and data 240 and send the campaigns and data 240 to the DMP 130 via the integrations 230 and the intelligent database 150. The DMP 130 may provide the campaigns and data 240 to the client(s) 190 for use in ads and campaigns 210 that are provided to one or more of the data sources 110 (e.g., the customers 105) via, for example, web, mobile, social, or IoT products, devices, and/or services.

The DMP 130 integrates data by anonymously integrating data streams from multiple data sources (e.g., the first-party data 113 and the third-party data 117). The DMP 130 unifies audiences by consolidating and unifying audiences for cross channel and contextual targeting. The DMP 130 provides analytics by providing audience insights using the first-party data 113 and the third-party data 117. The DMP 130 also provides activation by creating audiences and activates against specific segments, cross channel/cross device, and on site.

The DMP 130 provides insights, such as audience intelligence and segmentation. By integrating all of the data sets, richer audience profiles can be created. This allows far greater insights that can be leveraged to enhance the web experience, fuel strategic direction, and build audience segments for targeting. Insights can provide dashboard access for a client's own data, and/or comprehensive data based on multiple clients' data, depending on the implementation.

In some implementations, segments can be defined by a client (e.g., based on geography, demographics, behaviors, psychographics, etc.), but segments can also be generalized, such as with respect to how a customer shops: “brand loyal”, “price shopper”, “switcher”, “heavy user”. For example, in an advertising campaign, a client may send a switcher an offer for $20 off one purchase, send a brand loyalist an offer for $20 off two purchases, send a price shopper an offer for a refund of a first amount, and send a heavy user an offer for a refund of a second amount different than the first amount (e.g., wherein the second amount is greater than the first amount).

Normalized data includes customer/user demographics, shopping, interests, ownership, custom information, site/call behavior, entertainment, travel, for example. It is noted that PH is not needed.

The DMP 130 provides activation which is acting on insights to drive improvements. The DMP 130 increases efficiencies and increases customer experience by targeting the right audience and exploring new opportunities. New audiences are reached by leveraging cross channel audiences and look-alikes. There is an increase in effectiveness through higher conversion, action, and response rates. In some implementations, activation is the start of an advertising campaign or a marketing campaign.

Activation includes media suppression, site personalization, call personalization, media personalization, look-alike modeling, sales event, and digital persona discovery, for example.

Media suppression excludes recent purchasers or audiences with a low probability to convert. This reduces media waste and excessive wear out on a client's media buys.

Site personalization leverages first- and third-party data to provide a more relevant experience. It increases site conversions and brand affinity due to personalized content.

Call personalization leverages first- and third-party data to provide a more relevant experience. It increases call conversions and brand affinity due to personalized conversation.

Media personalization leverages first- and third-party data to provide a more relevant experience. It increases media engagement and brand affinity due to personalized content.

Look-alike modeling leverages first-party data to reach new audiences that look similar to recent purchasers. It increases reach and targets new audiences.

Sales event leverages first-party data to identify sales event buyers and target audiences that look similar. It provides more contextual relevant messaging, content, and creativity across digital channels.

Digital persona discovery leverages first- and third-party data to refine digital personas to increase media effectiveness and site engagement and experience. It increases engagement with the brand on the right device.

Data can be collected at the DMP 130 using, for example, tags placed on websites and in mobile apps (usually in an app's software development kit (SDK)); APIs; calls initiated to the organization maintaining the DMP 130; and cookie syncing and data enrichment from third-party data sources, and first-party data.

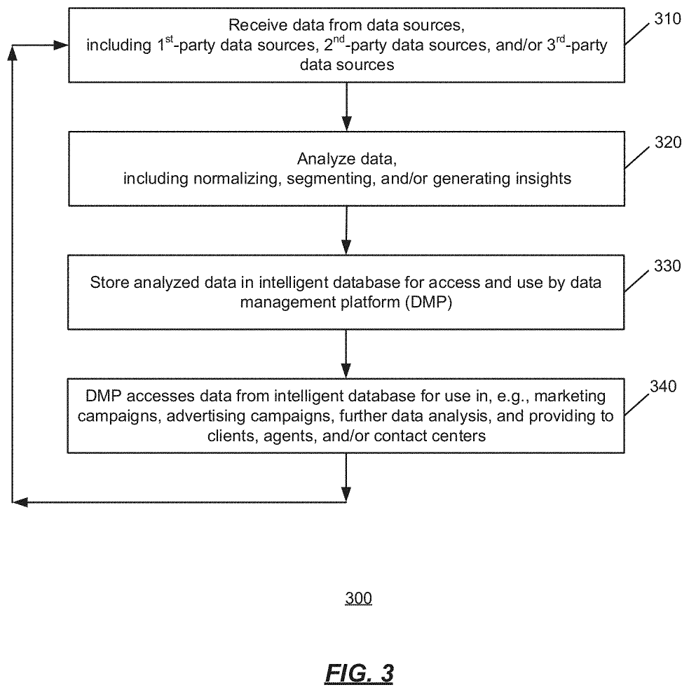

FIG. 3 is an operational flow of an implementation of a method 300 that may be performed by a DMP, such as the DMP 130. At 310, data is received, e.g., at the intelligent database, from various data sources, such as the data sources 110, including first-party data sources 112, second-party data sources 114, and/or third-party data sources 116.

At 320, the data, which may comprise first-party data 113, second-party data 115, and/or third-party data 117, is analyzed, e.g., by a processor or computing device comprised within, or associated with, the DMP 130 and/or the intelligent database 150. A suitable computing device is illustrated in FIG. 37 as the computing device 3700. The analysis may comprise normalizing the data, segmenting the data, and/or generating insights using the data, for example, depending on the implementation.

At 330, the analyzed data, further described herein, is stored in the intelligent database 150. The DMP 130 is configured to access and use the data that is stored in the intelligent database 150.

At 340, the DMP 130 accesses the data from the intelligent database 150 for use in e.g., marketing campaigns, advertising campaigns, further data analysis, and providing to clients, agents, and/or contact centers, such as the client(s) 190, the agent(s) 175, and/or the contact center 170. The process continues at 310, as additional data is received from the various data sources.

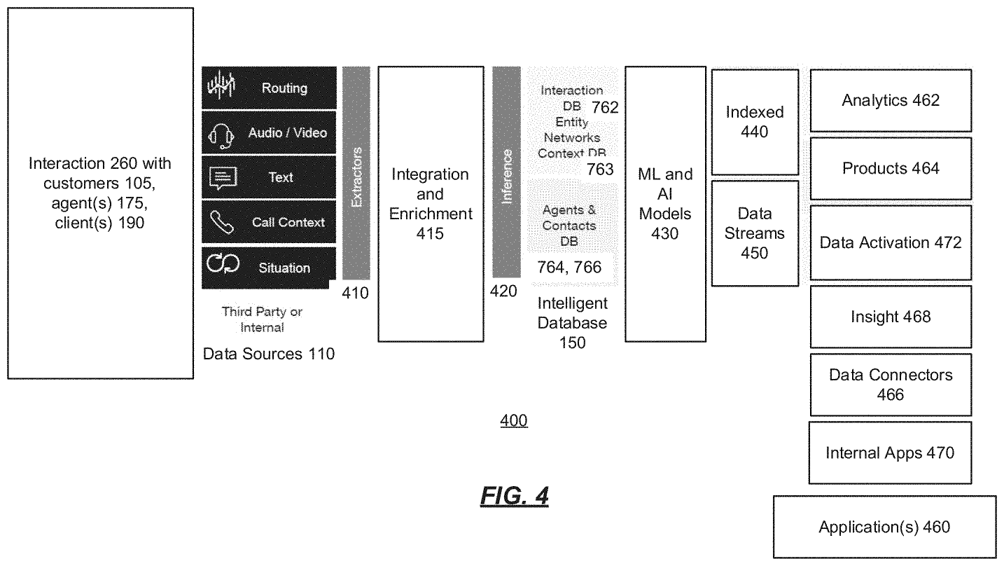

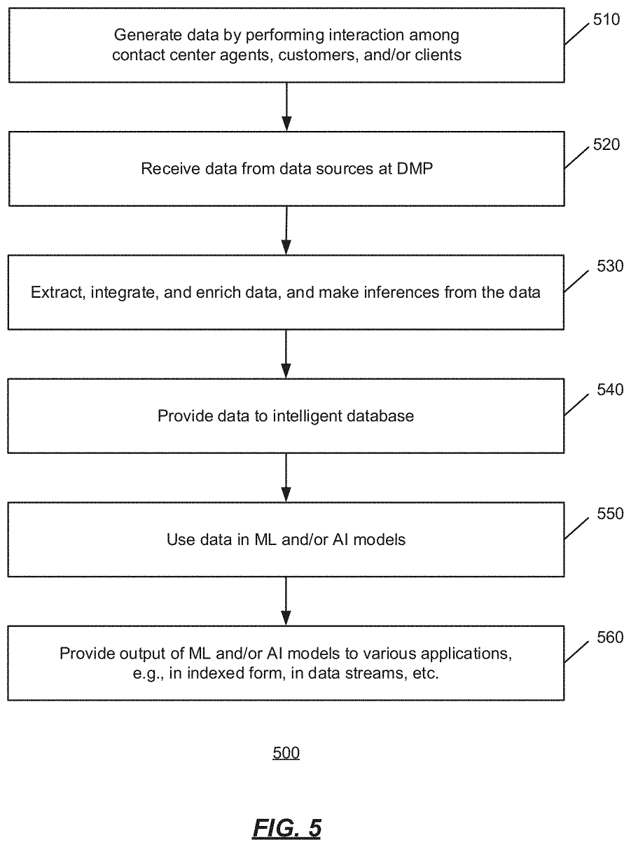

FIG. 4 is an illustration of an exemplary environment 400 for an intelligent database, such as the intelligent database 150, and FIG. 5 is an operational flow of an implementation of a method 500 that may be performed using an intelligent database, such as the intelligent database 150.

At 510, data is generated by performing an interaction 260. The interaction 260 may take place among customers 105, one or more agents 175, and/or one or more clients 190. The interaction 260 results in data (e.g., from the data sources 110). This data is provided to extractors 410 in the DMP 130, where it is received at 520.

Thus, in an implementation, data is collected at the DMP 130. Each browser on desktop and laptop computers generates a unique cookie ID. Each tablet and mobile phone generates a unique device ID. The DMP 130 stores all data at the cookie ID or device ID level. There is no PII, but there may be hundreds of millions of IDs. One person could be associated with many cookie IDs and device IDs. Essentially, each person is a set of cookie IDs and/or device IDs.

At 530, at the DMP 130, the data is extracted, integrated, and enriched, e.g., using an integration and enrichment module, and inferences are made regarding the data. At 540, data, including the enriched data, and the inferences are provided to the intelligent database 150, where they are stored (e.g., in one or more of various databases, such as an interaction database 762, and entity networks context database 763, an agents database 764, and/or a contacts database 766).

In an implementation, profiles are built. During the profile-building stage, the DMP may merge the newly collected data together; transform data into events and profiles; match data sets together using common identifiers, e.g., email addresses, username, phone numbers or probabilistic methods and potentially signatures; and perform segmentation (e.g., build target audiences for each industry). A signature could be a combination of location, phone number, accent, language, and other data points, for example, which can build a signature for customers.

A signature may comprise a sparse matrix in some implementations. The more data points that are used for a customer, the more accurate is the customer identification. Phone numbers may be used in a hash function.

Segmentation involves creating audiences based on the attributes found in the user profiles. For example, an advertiser promoting golf equipment in the California area could create an audience segment that comprises the following attributes: male, aged 45-60, lives in California, interested in golf, and has made at least 2 online purchases of golf-related products in the past 60 days. A segment may be considered to be, or comprise, a collection of demographics and psychographics.

At 550, the data from the intelligent database 150 is provided to machine learning (ML) and/or artificial intelligence (AI) models 430. At 560, the output of the ML and AI models 430 is provided (in indexed 440 form and/or as data streams 450) to one or more applications 460.

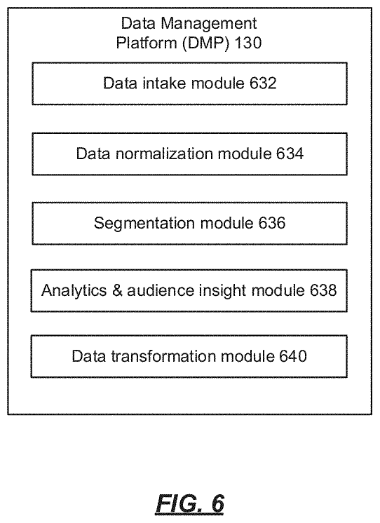

FIG. 6 is a diagram of an example DMP. In an implementation, the DMP 130 comprises a data intake module 632, a data normalization module 634, a segmentation module 636, an analytics and audience insights module 638, and a data transformation module 640.

The data intake module 632 is configured to receive data from data sources such as the data sources 110, including first-party data sources 112, second-party data sources 114, and/or third-party data sources 116.

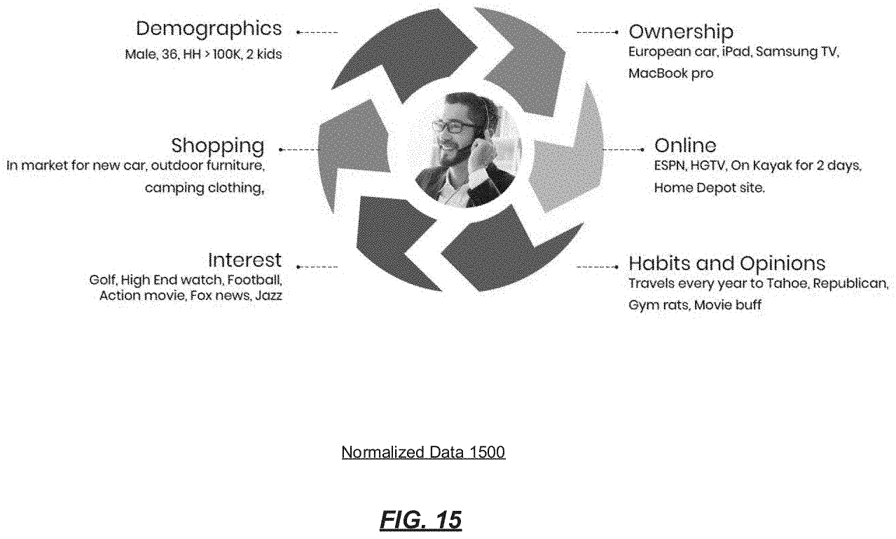

The data normalization module 634 is configured to receive data from the data intake module 632 and normalize the data. Normalized data is described further herein with respect to FIG. 15, for example. The segmentation module 636 may be configured to generate segments, e.g., regarding customers. As described further herein, each customer has many segments associated with them, and each segment has a percentage of value, weight, or importance relative to the other segments of that customer. A customer DNA may be generated using the segments and percentages. DNAs among people (e.g., customers) may be compared to determine the various products, services, advertisements, etc. each person may be interested in.

The analytics and audience insight module 638 is configured to perform analytics on data, and provide insights regarding customers. In an implementation, insights are based on capturing as much data as possible, and no personally identifiable information (PII) is needed. The insights may be provided and displayed to a user, such as one of the clients 190, via a dashboard. In some implementations, activation is the start of an advertising or marketing campaign, and then after activation, an analytics dashboard may be displayed, and then integration may be performed. Clients may use dashboards to analyze different segments. Clients may use segments to activate campaigns, such as marketing campaigns and/or advertising campaigns, for example. A dashboard may allow a client to view various metrics regarding segments, compare segments against each other, view statistics (e.g., distribution of metrics over any parameter, such as demographics for example), and generate lists for import and export, etc. In this manner, for example, customers may be scored to determine high risk, moderate risk, and low risk customers (e.g., and further analyzed with respect to age, gender, location, sentiment, etc.), and high risk customers may be identified and appropriate action(s) taken (email, phone call, etc.) to try to reach and maintain the high risk customers.

The data transformation module 640 is configured to receive data and transform the data into another form or format, such as combining the data with other data, performing functions or other manipulations on the data, extracting one or more subsets of the data from the data, etc.

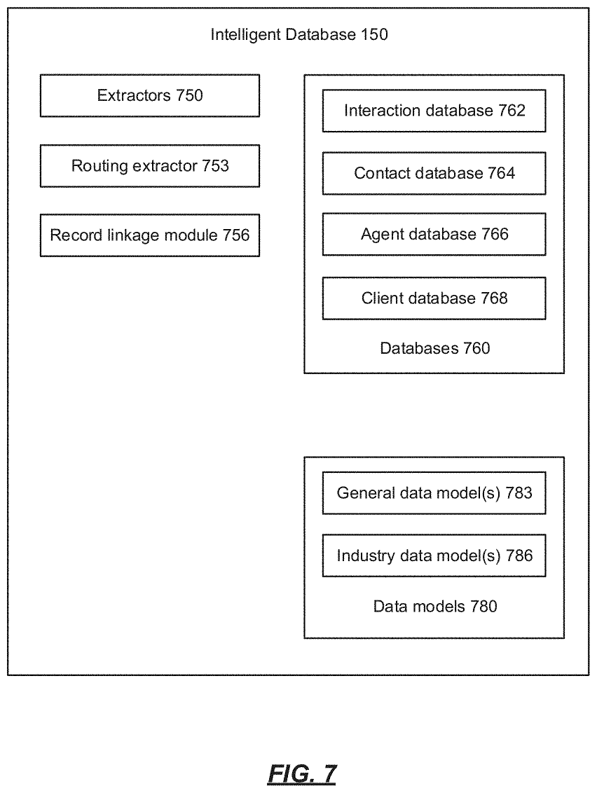

FIG. 7 is a diagram of an example intelligent database 150. The intelligent database 150 provides a data platform for research and development and for data science to try new ideas learn from the data, find interesting patterns, extract insights, and apply machine learning algorithms with the goal to generate insights from data. Machine learning decides what to keep and what to discard.

The intelligent database 150 may comprise extractors 750, a routing extractor 753, and a record linkage module 756. The intelligent database 150 may comprise various databases 760, such as an interaction database 762, a contact database 764, an agent database 766, and a client database 768, for example. The intelligent database 150 may contain additional or fewer databases, depending on the implementation. Additionally, the intelligent database 150 may contain data models 780, such as one or more general data model(s) 783 and one or more industry data model(s) 786.

The intelligent database 150 comprises extractors 750, a routing extractor 753, and a record linkage module 756. The extractors 750 is a module that is responsible for extracting data from a variety of data sources, including channel specific features. The routing extractor 753 is a module that is responsible to extract all routing information from an interactive voice response (IVR) path to the agent. The record linkage module 756 is a module that is responsible for merging two or more data sources and mapping them to each other. The challenge here is to find the most accurate source or to merge with a probabilistic approach. This layer also has to maintain consistency among all elements.

The interaction database 762 may contain data pertaining to interactions that have occurred among customers 105, one or more agents 175, and/or one or more clients 190.

The contact database 764 may contain data pertaining to contacts, such as customers 105.

The agent database 766 may contain data pertaining to agents of one or more contact centers, such as the agents 175 of the contact center 170. Data pertaining to many agents of many different contact centers may be stored in the agent database 766.

The client database 768 may contain data pertaining to one or more clients, such as the client 190. Data pertaining to many clients may be stored in the client database 768.

The general data model(s) 783 and the industry data model(s) 786 may be used for data analysis, such as for ad campaigns and marketing, as described further herein.

The intelligent database 150 may comprise a SQL or noSQL database to store the data. Databases may include an interaction database that is a database of every call and associated features, a contact database that is a database of callers and associated attributes, an agent (user) database that is a database of agents and relevant attributes, and a client database that is a database for every client 190.

The intelligent database 150 may comprise additional modules such as an updater that is responsible to update the database in designed period of intervals. The updater can read from events stream with a module to keep the consistency. An API may be provided that is a module responsible to provide the data to outside. A search module may provide a fast access to search for any combination of attributes and items, such as searching for any caller, agent, call feature, any demographics and/or psychographics, and searching at concept level (e.g., topic) as well as at word level.

All data and interactions are mapped to a data model. There are two data models: a general data model and an industry focused data model. A specific data model may be used for each particular industry (e.g., airline industry will have “from” and “to” because these are industry focused and related to the airline industry, and not generally applicable to all industries (e.g., such as “estimated wait time”)).

Each data point in the intelligent database 150 is identified as either fact-based, calculated, or inferred. For example, the time of a call is fact-based, the call time is calculated, and the topic of the call is inferred.

Each data point will be associated with a probability. A data science algorithm may be used to assign probability to every single data point.

Every single data point in the intelligent database 170 has a set of timestamps associated with it, e.g., directed to the time of the event, the time of the record, etc.

The intelligent database 150 can be built over time. For example, a data science module that can detect the gender of the caller might be developed now and is going to apply later. However the time of every single call can extracted at the moment.

The intelligent database 150 is scalable and fast (e.g., able to respond within millisecond). The intelligent database 150 is API based (e.g., any communication with the intelligent database 150 should be via API and should able to open to the outside via API as well).

The intelligent database 150 is secure, and is payment card industry (PCI), Health Insurance Portability and Accountability Act (HIPAA), and General Data Protection Regulation (GDPR) compliant. Access to the intelligent database 150 is physically and logically secure, with strong access control. Privacy is maintained, and PII data (if there is any) is physically and logically separated.

The intelligent database 150 is configured to extract demographics from conversation (text or voice) (demographics: gender, age, etc.), extract demographics from CRM; from context; from 3rd party; extract address from CRM; extract customer information/features from CRM; from voice conversation (features: personality type, education, race, generation such as first gen or second gen, ethnicity, accent, psychographics, city, zip code, state, previous issues, marital status, number of children, home value, etc.).

The intelligent database 150 is configured to extract psychographics from text conversation.

The intelligent database 150 is configured to extract personality type (of the 16 known personality types, as an example) from text and voice conversations.

The intelligent database 150 is configured to extract topics of calls from text conversation. For example, represent each topic with 5 words. Identify trends of the top 1, 3, 5, topics in last day, week, month. Identify topic trends. Represent topics with one or two words, for example.

The intelligent database 150 is configured to extract call features are time of call (wait time, estimated wait time; hold time, call duration, channel, disposition, IVR path (first, last, path); transferred or not, average handle time (AHT); number of agents at the time, time of call, day of call, day of the week, holiday yes or no, long weekend yes or no, special/holidays. Extract agent information for the call. Extract contact center status at the time of the call.

The intelligent database 150 is configured to extract agent information from CRM and/or from conversation, such as gender, age, longevity, personality type, education, race, generation such as first gen or second gen, ethnicity, accent, CSAT (customer satisfaction), retention rate, psychographics, sales conversion, state, language, best IVR performance. Agent performance may be calculated based on set of metrics.

The intelligent database 150 is configured to extract customer features from context—name, gender, age, phone number/area code, location (e.g., latitude, longitude, city, state, country, etc.), social IDs (e.g., Facebook, Twitter, Google, etc.).

The intelligent database 150 is configured to extract customer interaction from conversations and other data sources (customer mood, customer CSAT after the call, agent mood, empathy (extract from words), listener (ratio of listening to talking), polite (calling customer by their name).

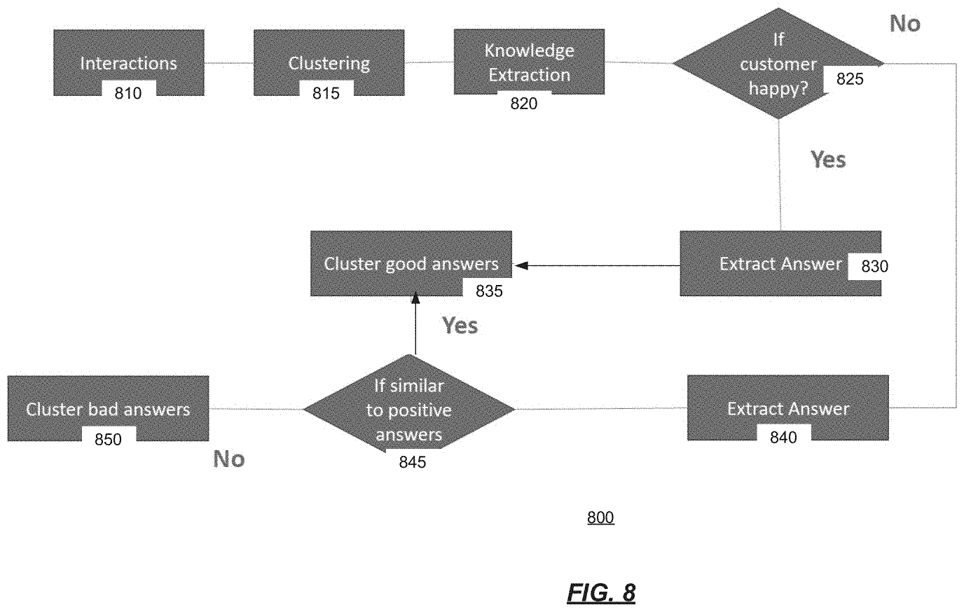

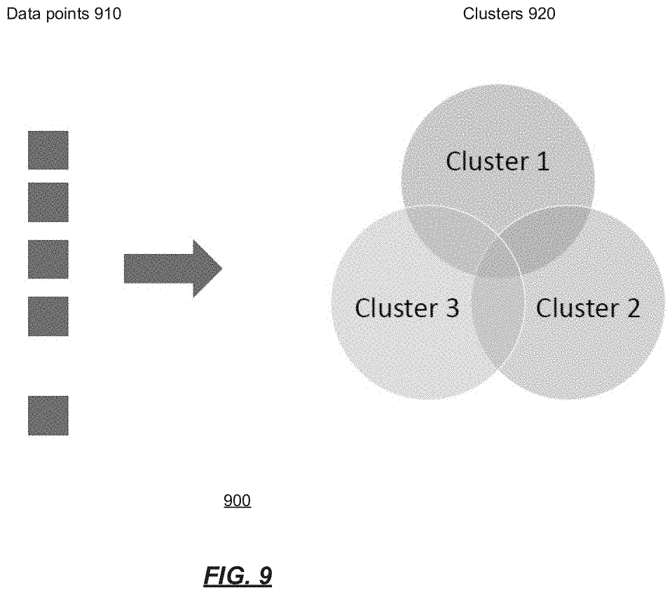

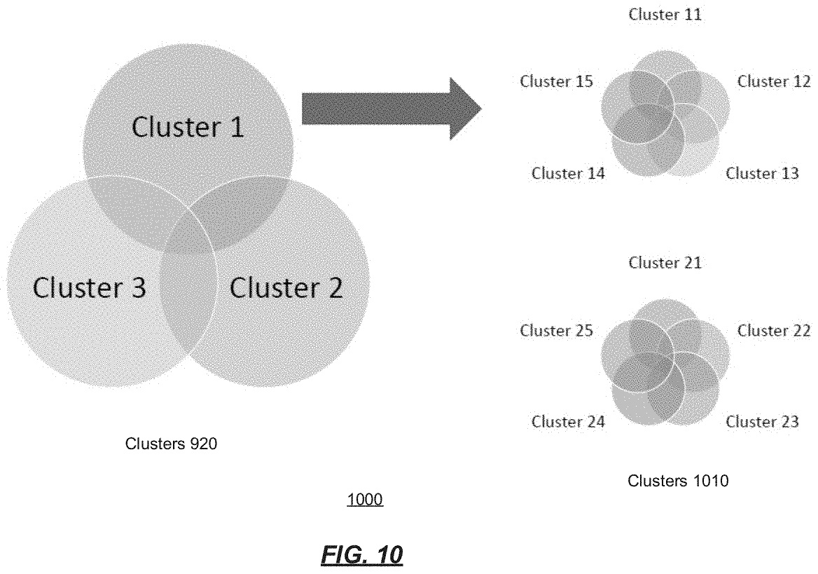

FIG. 8 is an operational flow of an implementation of a method 800 of extracting information for use with a DMP, such as the DMP 130. FIG. 9 is a diagram 900 illustrating clusters, and FIG. 10 is another diagram 1000 illustrating clusters.

At 810, interactions among customers, clients, and/or agents are captured.

At 815, data is extracted from the interactions, and clustering is performed. Clustering is used to group similar data and thus similar interactions. As shown, data points 910 (from data sources, interactions, etc.) are processed and formed into various clusters 920. Clusters 920 can be processed into further clusters 1010 depending on a desired level of granularity of data, in some implementations.

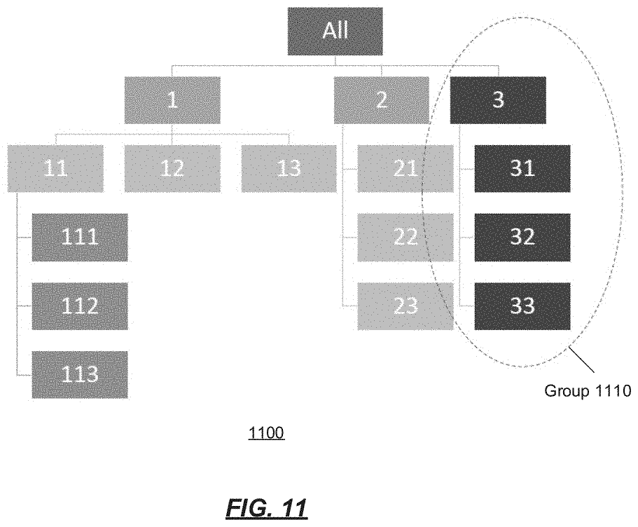

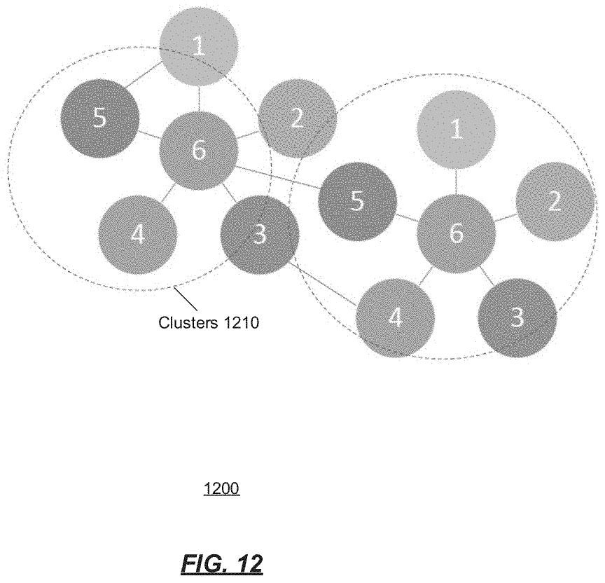

FIG. 11 is a diagram illustrating a tree 1100 with groups 1110, and FIG. 12 is a diagram illustrating a graph 1200 with clusters 1210. In an implementation, clusters of data may be grouped into groups 1110 and arranged in a tree 1100 for subsequent processing and analysis. In an implementation, a knowledge graph 1200 may be constructed to understand how concepts are connected to each other in a contact center. For example, a knowledge graph may show how questions are connected to each other (e.g., how much they share popular words). In this manner, knowledge (e.g., information) about communications, conversations, resolutions, etc. may be gleaned. In an implementation, each cluster has one or more questions and one or more answers to the question(s). The knowledge graph (also referred to as a graph) shows how the questions from various clusters are connected to each other (e.g., how much they share popular words).

Returning to FIG. 8, at 820, knowledge from the clusters is extracted and stored for future use.

At some point, a customer may call or chat with an agent regarding a customer service issue (e.g., inquiry or comment directed to a product or service), and it is determined after the call whether the customer is happy or not with the resolution of the customer service issue at 825. This determination may be made using keywords, tonal analysis, and/or other techniques.

At 830, when it is determined that the customer is happy, the answer that was provided to the customer service issue is extracted, and at 835, added to a cluster of good answers. Good answers are those that are determined to have positively resolved the customer service issue.

When it is determined at 825 that the customer was not happy with the resolution of the customer service issue, the answer that was provided to the customer service issue is extracted, and at 840, compared to the cluster of good (i.e., positive) answers at 845. If the answer is determined to be similar to the cluster of good answers, then it is added to the cluster of good answers, although it had been determined that the answer did not resolve the customer service issue positively in this instance.

On the other hand, when the answer that was provided to the customer service issue is compared to the cluster of good (i.e., positive) answers at 845, and it is determined that the answer is not similar to (i.e., dissimilar from) the cluster of good answers, then it is added to a cluster of bad answers at 850. The clusters of answers may be stored in the intelligent database 150 for subsequent analysis and future use (e.g., in customer service calls and chats).

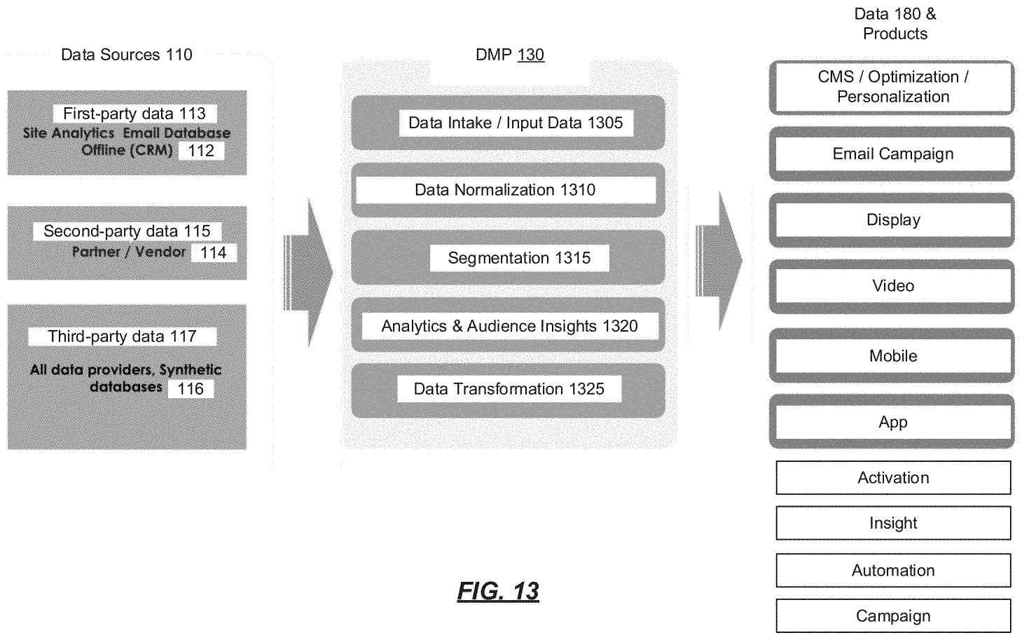

FIG. 13 is an illustration of example input and output of a DMP, such as the DMP 130. The input data to the DMP 130 comprises data from data sources such as the data sources 110, including first-party data sources 112, second-party data sources 114, and/or third-party data sources 116. This first-party data 113, second-party data 115, and/or third-party data 117 is provided to the DMP 130. Data intake 1305 is performed by the data intake module 632, followed by data normalization 1310 performed by the data normalization module, and segmentation 1315 performed by the segmentation module 636.

Analytics and audience insights may be performed by the analytics and audience insight module 638. Data transformation may be performed by the data transformation module 640.

The output of the DMP 130 comprises data 180. The data 180 may be in various forms and/or be for various uses or applications, such as CMS/optimization/personalization, an email campaign, display, video, mobile, and/or an app.

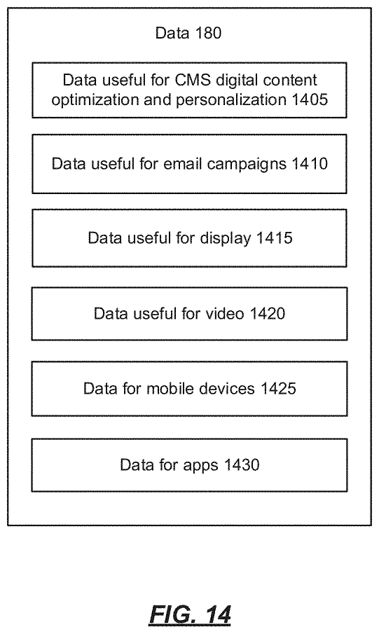

More particularly, FIG. 14 is a diagram of example types of data provided by a DMP, such as the DMP 130. The DMP 130 may output to the client 190 data 180 including data useful for content management system (CMS) digital content optimization and personalization 1405, data useful for email campaigns 1410, data useful for display 1415, data useful for video 1420, data for mobile devices 1425, and/or data for apps 1430. In some implementations, the data 180 is unique to the client 190 as it comprises data that the client 190 has not seen before.

FIG. 15 is an illustration of various types of normalized data 1500. After the data is received from the data sources 110 (e.g., via the data intake module 632), the data is normalized (e.g., by the data normalization module 634). In this manner, data is retrieved and normalized for each customer (i.e., standardized to a common subjects or subsets of a subjects) such as demographics, shopping, interests, ownership, site/call behavior, entertainment, travel, and other customized subjects (e.g., shown as “custom” in FIG. 15). Thus, for the customer in FIG. 15, the normalized data 1510 includes items like demographics (male, 38 years old, household income (HHI) about $100,000, etc.), shopping (in the market for garden furniture, live theater, etc.), interests (in the market for high-end clothing, golf, etc.), etc. In this manner, as described further herein, customers can be compared with one another and used to determine how other similar customers might behave, the data of other similar customers, the additional data of this particular customer based on other customers having similar normalized data, etc.

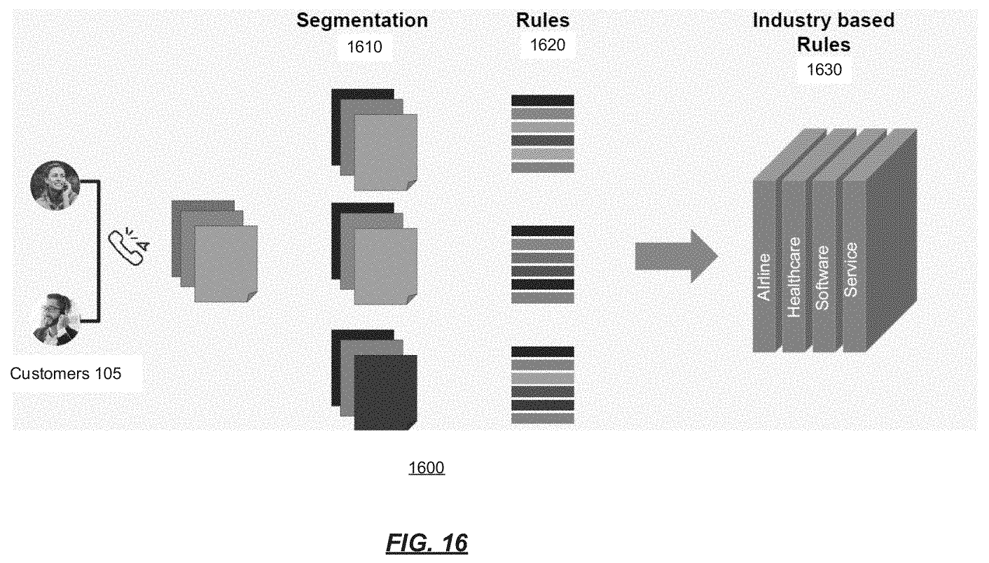

FIG. 16 is an illustration 1600 of the use of segmentation 1610 and rules 1620 to generate industry based rules 1630. Rules are based on a combination of standard attributes and features in the DMP and defined actions. Information from customers 105 undergoes segmentation 1610 as described further herein. The segments of the segmentation 1610 are applied to rules 1620. The application of segments to the rules 1620 results in industry based rules 1630 which can then be used by specific clients in particular industries, e.g., in their marketing campaigns, advertising efforts, etc. Industries may include airline, healthcare, software, service, etc.

Examples of rules are those based on gender, age, waiting time, and/or order history. For example, if the customer's gender is female, age is between 40 and 50 years old, waiting time is more than 15 minutes, and the customer is in the top 20% (of favored customers), then send a 20% discount code to the customer.

For “if then” rules, conditions may include, or be based on, demographics, psychographics, customer status, call status, customer personality, and/or customer sentiment, for example. Actions may include send email, send reminder, call, re-targeting, and/or up-sell, for example. An example rule is the customer's gender is male, the customer is happy, and the customer has ordered more than twice in the past 30 days, then send a 20% discount code to the customer.

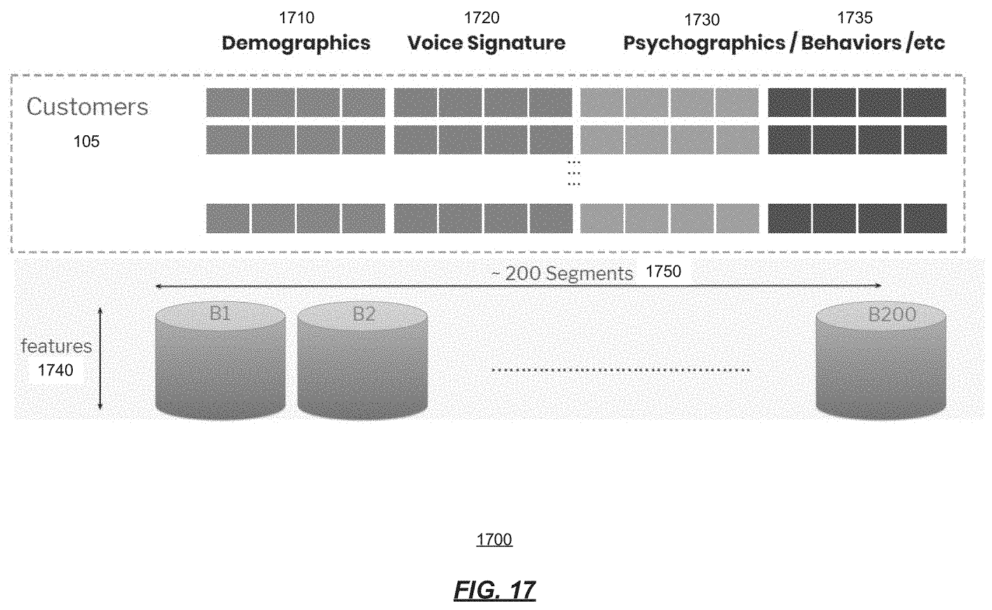

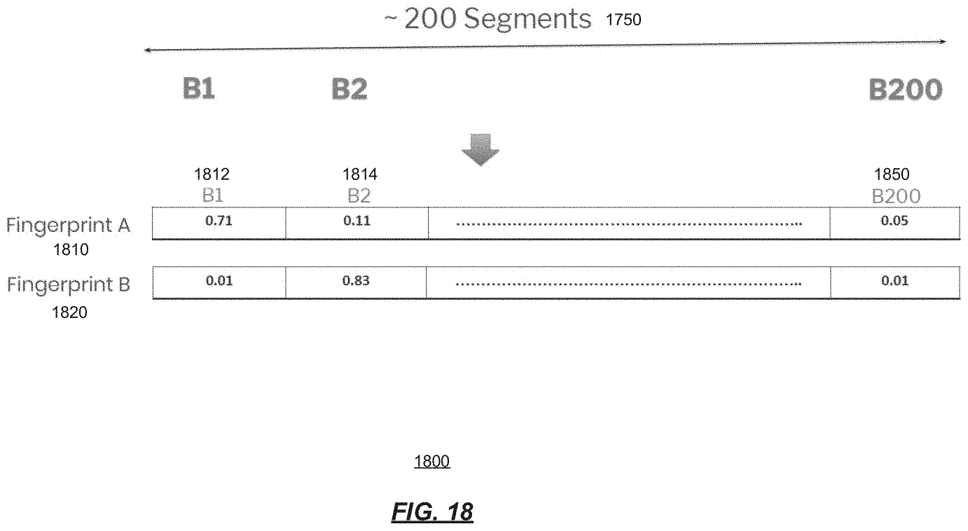

FIG. 17 is a diagram 1700 useful for illustrating segmentation, and FIG. 18 is a diagram 1800 useful for illustrating fingerprinting. Each customer of the plurality of customers 105 has a plurality of segments 1750 associated with them. Signatures may be transferred to cluster and/or segments, depending on the implementation. Machine learning may be used to determine what data to keep and what data to discard. Each segment is directed to one or more features 1740 of the customer. Each feature is based on one or more characteristics of the customer such as demographics 1710, voice signature 1720, psychographics 1730, behaviors 1735 (e.g., sentiment of the person, personality of the persons (e.g., identifying one of the popular or common personalities of the person)), phone number, etc.

A voice signature 1720 may be extracted from a conversation between the customer and an agent, for example. Extracting a voice signature may be performed using any well known technique, such as a fast Fourier transform (FFT) technique. Voice signatures are biometric signatures which have a very high probability of being unique.

Each individual segment of the segments 1750, shown as 1812, 1814, . . . 1850 in FIG. 18, for each individual customer is assigned a weight to represent how heavy the features of that segment is relative to same features of other individual customers. These segments with their weights are then combined, for each individual customer, to provide a “fingerprint” or “DNA” for each customer.

In some implementations, for each profile, a distribution over each segment for each customer is maintained. The results in private and secured data.

Thus, for example, in FIG. 18, one customer may have a fingerprint A 1810 comprising segment B1 1812 with weight 0.71, segment B2 1814 with weight 0.11, and additional segments with weights, including segment B200 1850 with weight 0.05. Another customer may have a fingerprint B 1820 comprising segment B1 1812 with weight 0.01, segment B2 1814 with weight 0.83, and additional segments with weights, including segment B200 1850 with weight 0.01.

The two fingerprints 1810 and 1812 represent two different customers, and can be used to compare how similar, relatively, the two customers are to each other, based on the weightings of each of the segments 1812, 1814, . . . 1850. The closer the weightings are, the more similar the customers are. The similarities or differences of the customers can be used to inform marketing and advertising campaigns in some implementations. For example, if it is known that the customer having fingerprint A 1810 likes to order pizza using their phone at 10 pm, and it is determined that the fingerprint B 1820 is similar (above a predetermined threshold, for example) to fingerprint A 1810, then it may be determined that the customer having fingerprint B 1820 also likes to order pizza using their phone at 10 pm, and thus appropriate marketing and/or advertising can then be directed to the customer having fingerprint B 1820 (e.g., coupons for pizza discounts sent to the phone of the customer having fingerprint B 1820 at 10 pm).

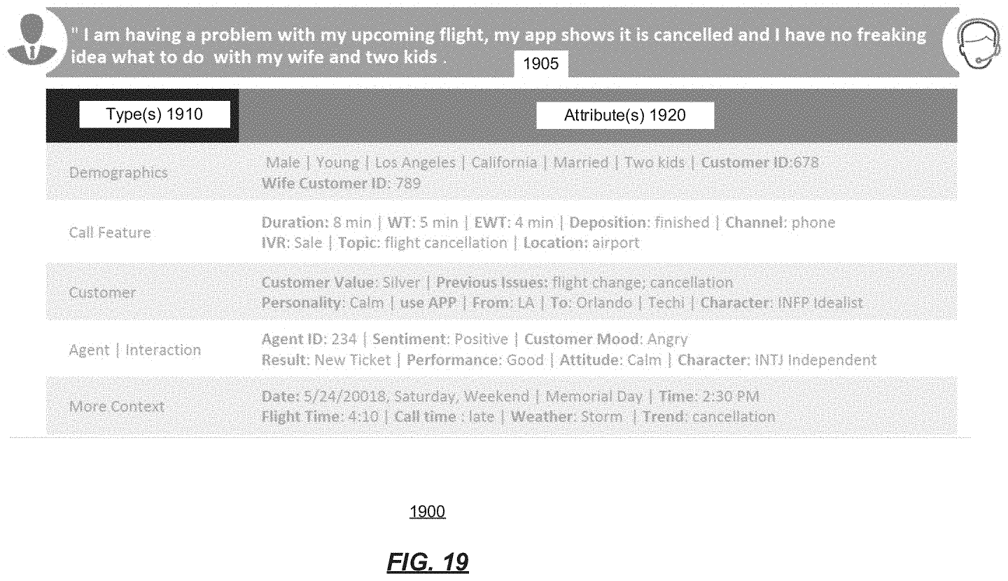

FIG. 19 illustrates an example of data 1900 extracted from a conversation that is used in segmentation. In this example, a customer calls an agent and discusses a problem with a flight, with a snippet of the conversation shown at 1905. The DMP 130 may extract one or more types 1910 of data from the conversation, and then assign one or more attributes 1920 to the types 1910.

The attributes 1920 may go to various types 1910 of data such as demographics, call feature data, customer data, agent and interaction data, and more context data. In this example, attributes for the demographics of the caller include determining that the caller is male, young, from Los Angeles, Calif., married, has two children, etc. These attributes may be determined or inferred from the conversation (e.g., from keywords and other analysis of the call). Attributes of the call features may include the duration of the call, the wait time (WT), the estimated wait time (EWT), the topic, where the call originated, etc. Attributes of the customer may include the customer's “status” level with the entity associated with the contact center the customer called into, other issues the customer has called about in the past, the personality of the customer, etc. Attributes of the agent and interaction may include the agent's id, the customer mood, the result of the call, the agent's demeanor, etc. Attributes of the more context may include the day, date, time, weather, etc.

The attributes 1920 may be determined by analyzing the conversation of the call between the customer and the agent, by analyzing the data pertaining to the call itself, and by analyzing contextual data pertaining to the call, for example.

The attributes 1920 can be used to generate data pertaining to the customer, segments relating the customer, fingerprints or DNA of the customer, and stored in the intelligent database 150 for future use by the DMP 130 in marketing and/or advertising campaigns for example, as described further herein.

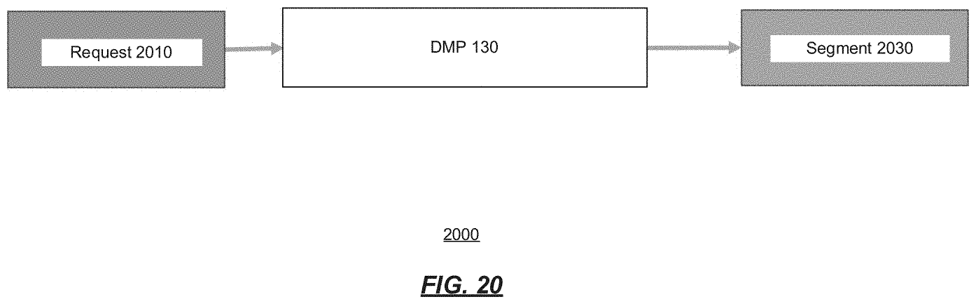

FIG. 20 is an operational flow of an implementation of a method 2000 of segmenting. A request 2010 for a segment is provided to the DMP 130. The DMP 130 receives the request and generates a segment 2030 using the techniques described herein.

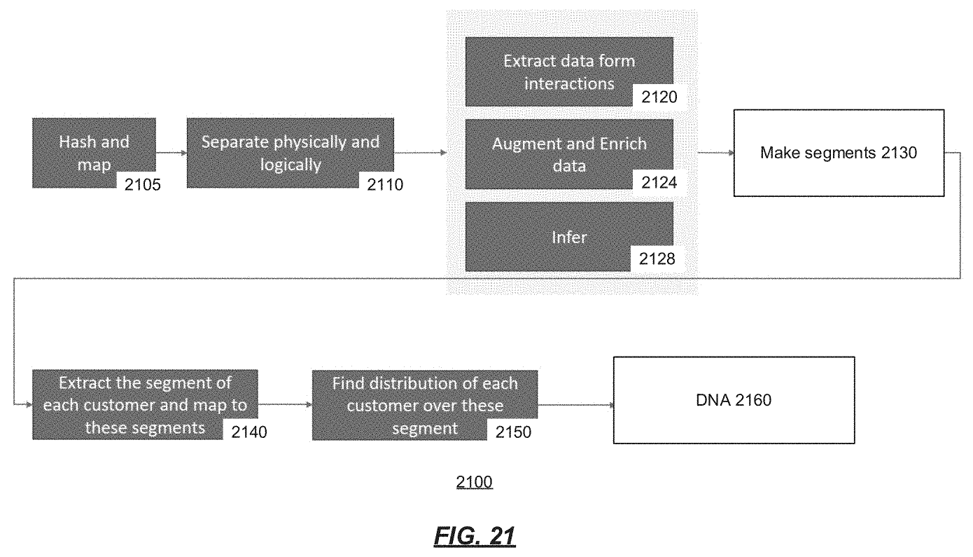

FIG. 21 is an operational flow of an implementation of a method 2100 of segmenting and generating a customer DNA (also referred to as a fingerprint). At 2105, data may be received from various sources, like data sources 110, and hashed and mapped to form an initial fingerprint for a customer (or fingerprints for multiple customers).

At 2110, the fingerprints may be separated physically and logically from each other, so that each customer's fingerprint is separate from the other customers fingerprints.

Interactions then occur between customers and agents at some point. The data from the interactions is extracted at 2120, augmented and enriched at 2124 with additional data, such as contextual data regarding the interactions, and inferences are made at 2128 (e.g., regarding characteristics of the customer such as demographics 1710, voice signature 1720, psychographics 1730, behaviors 1735, etc.

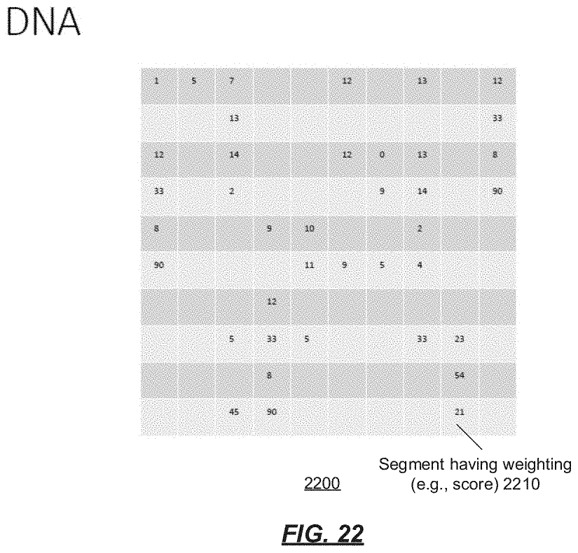

At 2130, segments 1750 are formed for each customer. At 2140, the segment(s) of each customer is extracted, and a mapping is created of the segments. At 2150, the distribution of each customer over each segment is determined. The distribution is the weighting that each segment for each customer is assigned. In this manner, a DNA for each customer can be formed at 2160. The DNA for each customer comprises each segment with a weighting (i.e., a distribution). FIG. 22 is an illustration 2200 useful for describing customer DNA. As shown, each segment has a weighting or score 2210 that corresponds to the strength (e.g., relative strength) of that segment's data, e.g., to the customer, to other customers, to a confidence value, etc., depending on the implementation.

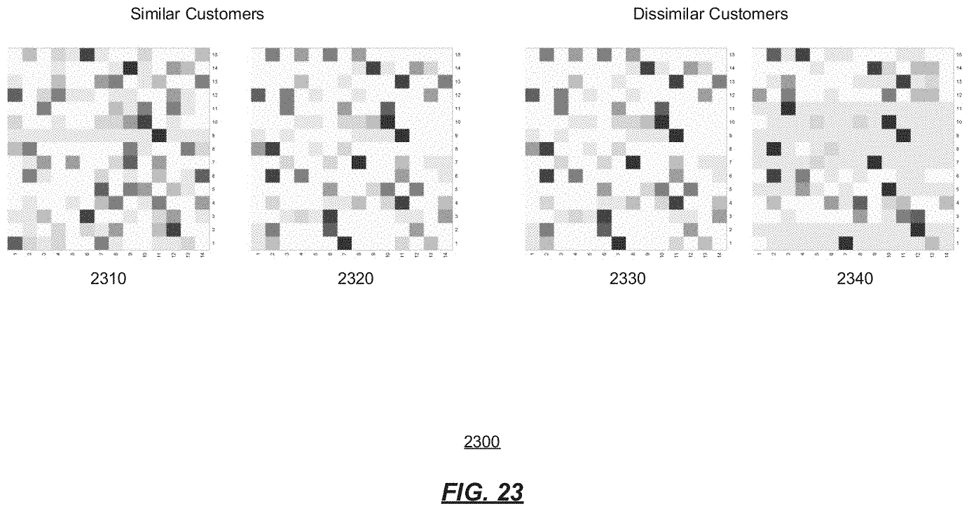

FIG. 23 is an illustration 2300 useful for describing customer DNA. Here, the DNA 2310 and 2320 are shown for two customers, respectively, who are determined to have similar DNA and thus are considered similar customers, and the DNA 2330 and 2340 are shown for two customers, respectively, who are determined to have dissimilar DNA and thus are considered dissimilar customers. Each block or square of each of the DNA 2310, 2320, 2330, 2340 represents a weighting of a segment of the customer who is associated with that particular DNA. In this example, the darker the block or square of each of the DNA 2310, 2320, 2330, 2340, the heavier the weighting (i.e., the scoring) for the feature(s) of the associated segment.

The weightings of the segments can be used to compare the DNA with each other, using one or more comparison algorithms for example, to determine levels of similarity or dissimilarity. In this manner, customers can be identified who may be similar to each other for marketing and/or advertising purposes, for example.

Here, the DNA 2310 and 2320 are compared to each other and it is determined that they are similar enough (they reach a predetermined similarity threshold) that their associated customers are considered to be similar. On the other hand, the DNA 2330 and 2340 are compared to each other and it is determined that they are dissimilar enough (they do not reach a predetermined similarity threshold) that their associated customers are considered to be dissimilar (i.e., different). In this manner, segments, features, characteristics, preferences of customers may be inferred from other customers who have been determined to be similar (and/or dissimilar) based on customer DNAs.

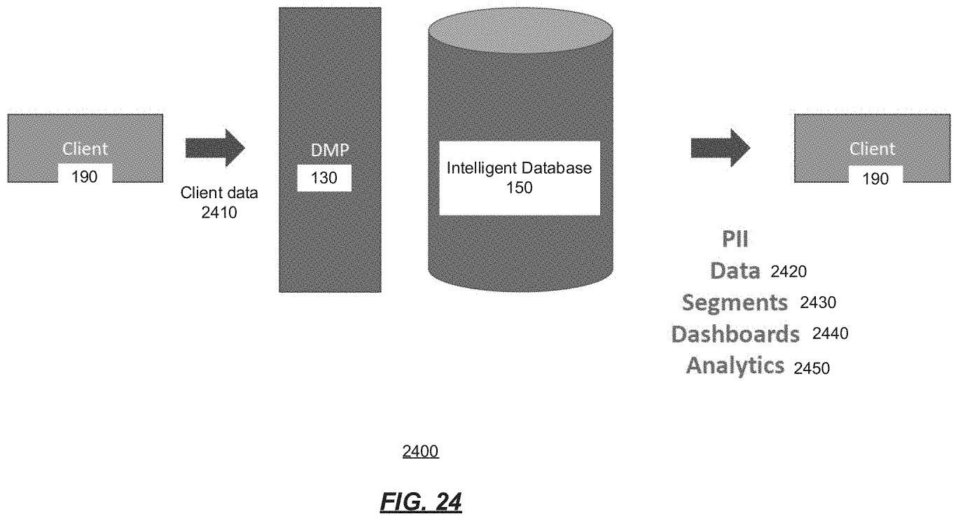

FIG. 24 is an operational flow of an implementation of a method 2400 of generating and providing output to a client 190. A client 190 provides client data 2410 to the DMP 130 and the intelligent database 150. The client data 2410 may comprise customer data of the client's customers and/or other data of the client, such as data from one or more partners of the client, data the client has purchased, etc. The DMP 130 and the intelligent database 150 process and store the client data 2410 using techniques described herein. Output may then be provided back to the client 190 in various forms such as PII data 2420, segments 2430, dashboards 2440, analytics 2450, etc. for subsequent use by the client 190. Note that in this example, PII data 2420 may be maintained. Moreover, in this example, data is maintained for each individual client 190, without mixing in other clients' data.

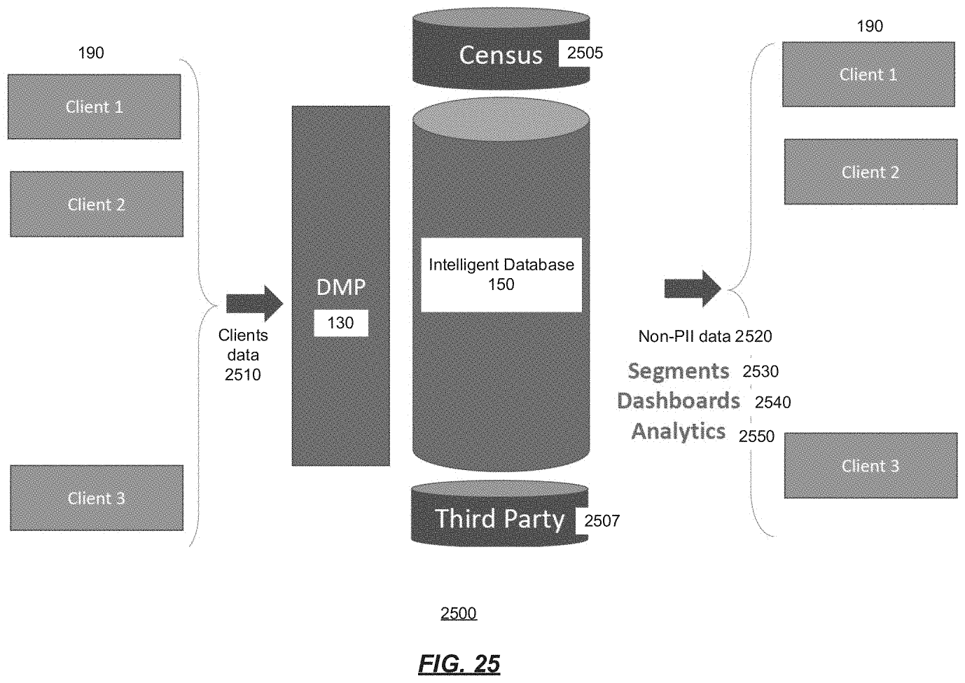

FIG. 25 is an operational flow of an implementation of a method 2500 of generating and providing output to clients. In this implementation, unlike the method 2400, data from multiple clients 190 is combined into one universal world, and used in conjunction with each other. In this manner, richer data and analysis may be provided to the clients 190 by the DMP 130 and the intelligent database 150. Each client is provided data and other output using data from multiple clients, with the same level of detail as if the data was based on data from the single client alone.

Thus, in the method 2500, a plurality of clients 190 provide clients data 2510 to the DMP 130 and the intelligent database 150. The clients data 2510 may comprise customer data of multiple clients customers and/or other data of the clients, such as data from one or more partners of the clients, data the clients each may have purchased, etc. The DMP 130 and the intelligent database 150 process and store the clients data 2510 using techniques described herein. Census data 2505 and third-party data 2507 may also be provided to the DMP 130 and/or the intelligent database 150, and used in the data analysis, storage, and outputs generated and provided by the DMP 130 and/or the intelligent database 150. A census may provide distribution data directed to demographics, for example. An address may be used for getting a distribution of the census data 2505. Output may be provided back to the clients 190 in various forms such as non-PII data 2520, segments 2530, dashboards 2540, analytics 2550, etc. for subsequent use by the clients 190. Note that in this example, non-PII data 2520 is maintained and provided. Thus, each client may receive cumulative data for multiple clients as with the same level of detail as if the data was from the single client.

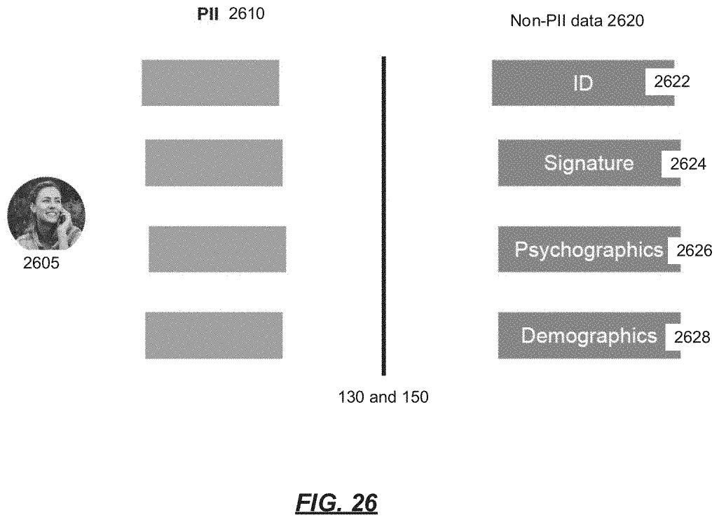

FIG. 26 is an illustration showing PII data being input and provided as non-PII data as output. Thus, as shown in FIG. 26, PII data 2610 of customers 2605 from one or more clients are provided to the DMP 130 and the intelligent database 150, and mixed and provided as output back to the clients as non-PII data 2620 such as ID (identifier) 2622, signature 2624, psychographics 2626, and demographics 2628 of each customer, for example. To track customers, a customer signature of every customer is built, in some implementations. A customer signature may be built using a hash function and a mapper, for example. A customer signature may be the same as the DNA described herein, or different from the DNA, depending on the implementation. Customer signatures may be transferred or otherwise provided to, or associated with, segments and/or clusters. Here, the signature is unique for each customer, while the identity of the customer is not known.

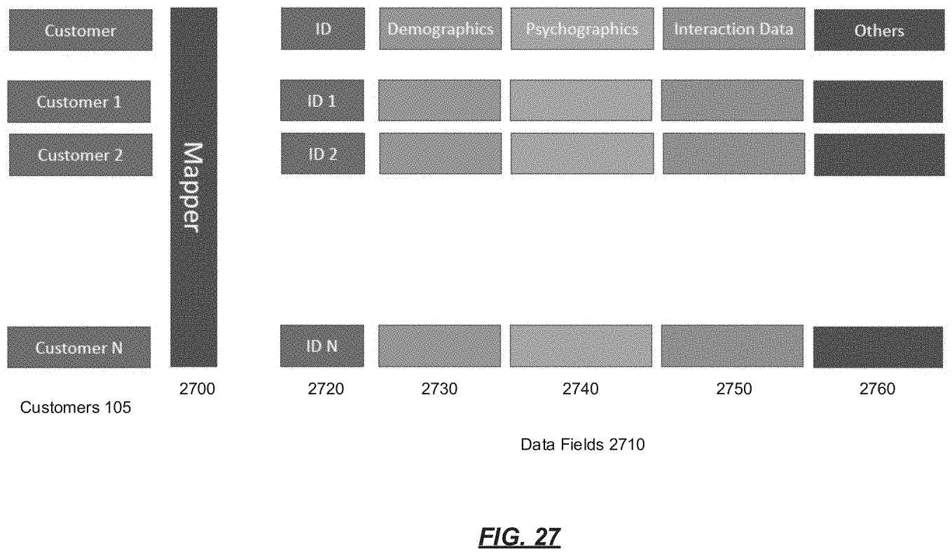

FIG. 27 illustrates the use of a mapper 2700. Information and data from customers 105 is received at the mapper 2700 and mapped to various data fields 2710 (which may be comprised within one or more segments, in some implementations). Example data fields 2710 include ID 2720, demographics 2730, psychographics 2740, interaction data 2750, and others 2760.

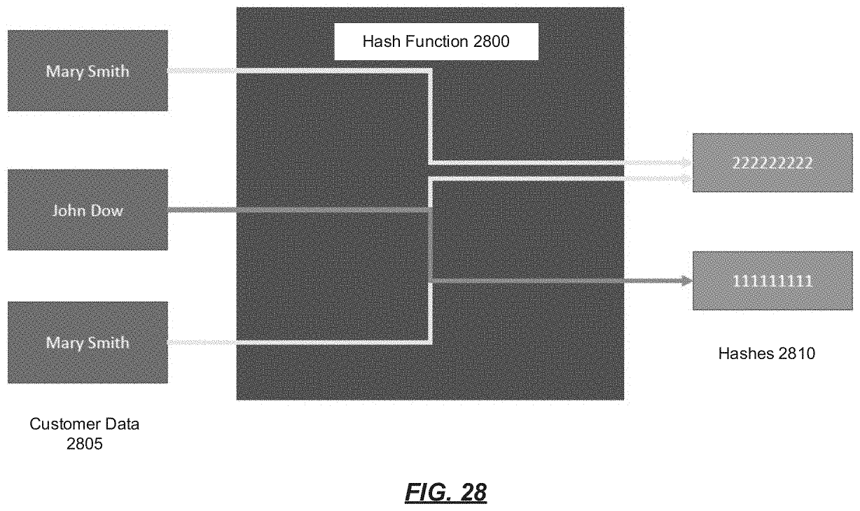

FIG. 28 illustrates the use of a hash function 2800. The hash function 2800 may receive customer data 2805 as input, and then generate hashes 2810 (e.g., hash values, hash codes, digests, etc.) which may be use as indices to a hash table, and used in conjunction with a mapper to form customer fingerprints.

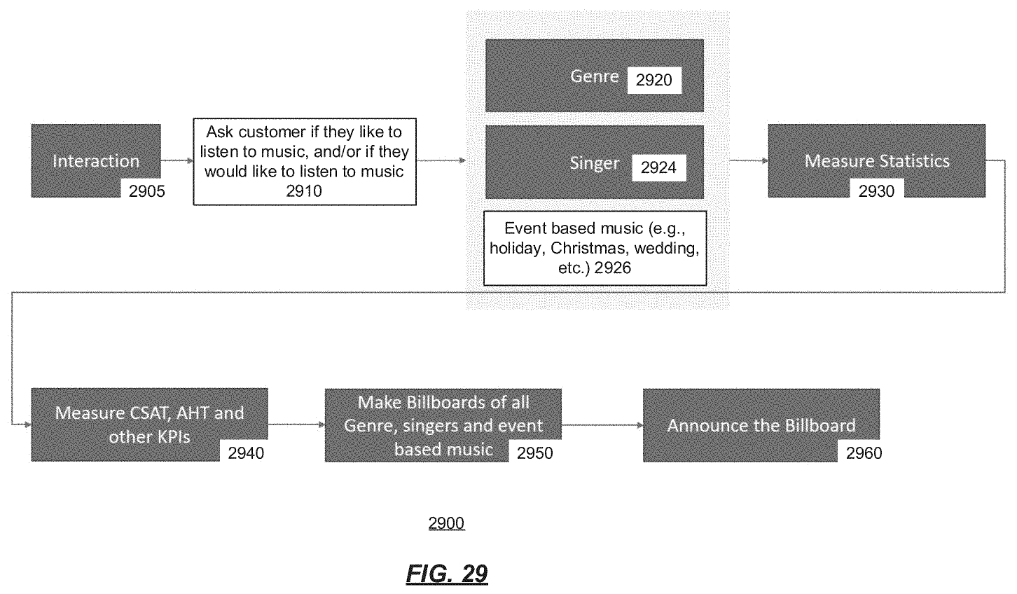

FIG. 29 is an operational flow of an implementation of a method 2900 of generating and providing a billboard.

At 2905, an interaction occurs between a customer and a contact center (e.g., a human agent and/or a virtual agent of the contact center). During the interaction, the customer is asked, e.g., by the DMP 130 or other platform such as an ad and marketing platform, if they like to listen to music and/or if they would like to listen to music, at 2910.

If the customer indicates at 2910 that they do like to listen to music and/or would like to listen to music, then the genre 2920, singer 2924, and/or event based music 2926 (e.g., holiday music, Christmas music, wedding music, etc.) that the customer likes is determined. Additional or alternative characteristics, features, and/or aspects of music may also be determined, depending on the implementation. The genre 2920, singer 2924, and/or event based music 2926 that the customer likes may be determined, by the DMP 130 or other platform, using any one or more of techniques, including for example, polling the customer, asking the customer one or more questions and/or to make one or more music selections, viewing music selections previously made and/or currently made by the customer, viewing segments or DNA (fingerprints) of the customer and/or other customers, etc.

At 2930, statistics regarding the characteristics, features, and/or aspects of music (e.g., the genre 2920, singer 2924, event based music 2926, etc.) that customers have indicated as liking are compiled and determined, e.g., by the DMP 130, the intelligent database 150, and/or other platform such as an ad and marketing platform.

At 2940, key performance indicators (KPIs) regarding the interaction and/or music are measured (e.g., by the DMP 130, the intelligent database 150, and/or other platform such as an ad and marketing platform), along with other metrics and indicators such as customer satisfaction (CSAT) and (average handle time (AHT)), for example.

At 2950, using the statistics of 2930 and the measurements of 2940, one or more billboards are generated of the characteristics, features, and/or aspects of music (e.g., the genre 2920, singer 2924, event based music 2926, etc.) that customers have indicated as liking (or not liking, or preferring or not, etc., for example). The one or more billboards are announced at 2960 (e.g., by the DMP 130, the intelligent database 150, and/or other platform such as an ad and marketing platform). Announcing the billboard(s) may comprise outputting the billboards to one or more clients, contact centers, and/or customers, depending on the implementation.

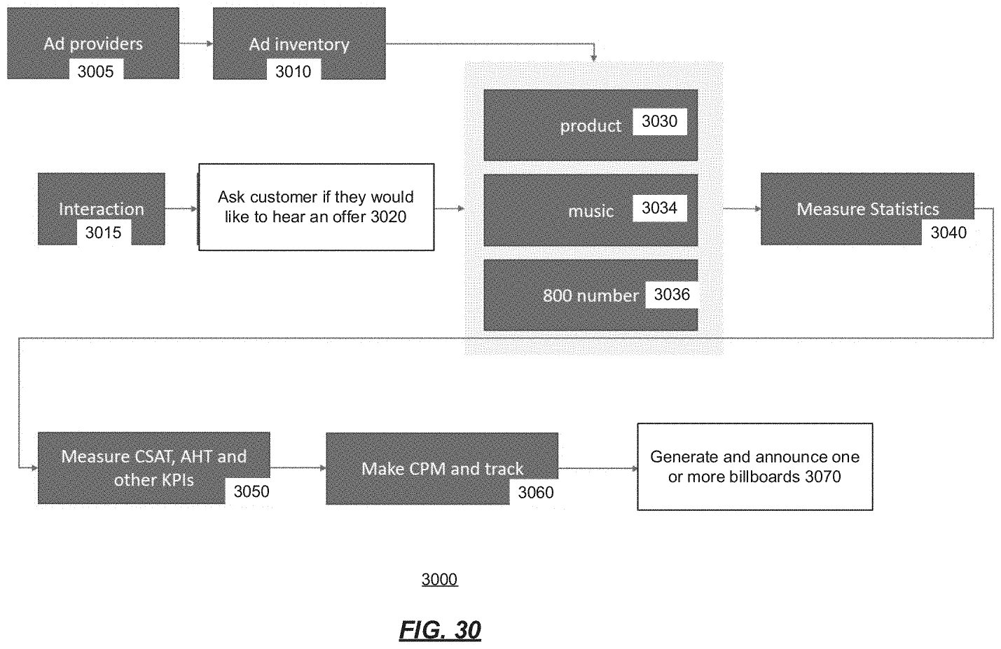

FIG. 30 is an operational flow of another implementation of a method 3000 of generating and providing a billboard, e.g., by the DMP 130, the intelligent database 150, and/or other platform such as an ad and marketing platform.

Ad providers 3005 and ad inventory 3010 (from one or more of the ad providers 3005) are provided to the DMP 130, the intelligent database 150, and/or other platform such as an ad and marketing platform.

At 3015, an interaction occurs between a customer and a contact center (e.g., a human agent and/or a virtual agent of the contact center). During the interaction, the customer is asked, e.g., by the DMP 130 or other platform, if they would like to hear an offer, at 3020.

When the customer agrees to hear an offer (from 3020), the DMP 130, the intelligent database 150, and/or other platform, such as an ad and marketing platform, determines one or more offers (ads) to play to the customer. The offer(s) (ad(s)) are determined from the ad providers 3005 and the ad inventory 3010, and may comprise information about a product 3030, music 3034, and/or an 800 phone number (or other phone number) to call 3036 for more information or to place an order, for example. Additional or alternative information may be provided, depending on the implementation.

The product 3030, music 3034, and/or an 800 phone number (or other phone number) to call 3036 that are comprised in the offer provided to the customer may be determined, by the DMP 130 or other platform, using any one or more of techniques, including for example, polling the customer, asking the customer one or more questions and/or to make one or more offer or other selections, viewing offer selections previously made or acted on by the customer, viewing segments or DNA (fingerprints) of the customer and/or other customers, etc.

At 3040, statistics regarding the characteristics, features, and/or aspects of the offer (e.g., the product 3030, music 3034, and/or a phone number to call 3036, etc.) that customers have indicated as liking or have acted on are compiled and determined, e.g., by the DMP 130, the intelligent database 150, and/or other platform such as an ad and marketing platform.

At 3050, key performance indicators (KPIs) regarding the interaction and/or the offer(s) are measured (e.g., by the DMP 130, the intelligent database 150, and/or other platform such as an ad and marketing platform), along with other metrics and indicators such as customer satisfaction (CSAT) and (average handle time (AHT)), for example.

At 3060, one or more customer portfolio management (CPM) files pertaining to the customers may be generated, maintained, and tracked for one or more clients, e.g., for use in marketing and ad campaigns.

At 3070, using the statistics of 3040 and the measurements of 3050, one or more billboards are generated of the characteristics, features, and/or aspects of the offer (e.g., the product 3030, music 3034, and/or a phone number to call 3036, etc.) that customers have indicated as liking or have acted on (or not liking, or preferring or not, etc., for example). The one or more billboards are announced at 3070 (e.g., by the DMP 130, the intelligent database 150, and/or other platform such as an ad and marketing platform). Announcing the billboard(s) may comprise outputting the billboards to one or more clients, contact centers, and/or customers, depending on the implementation.

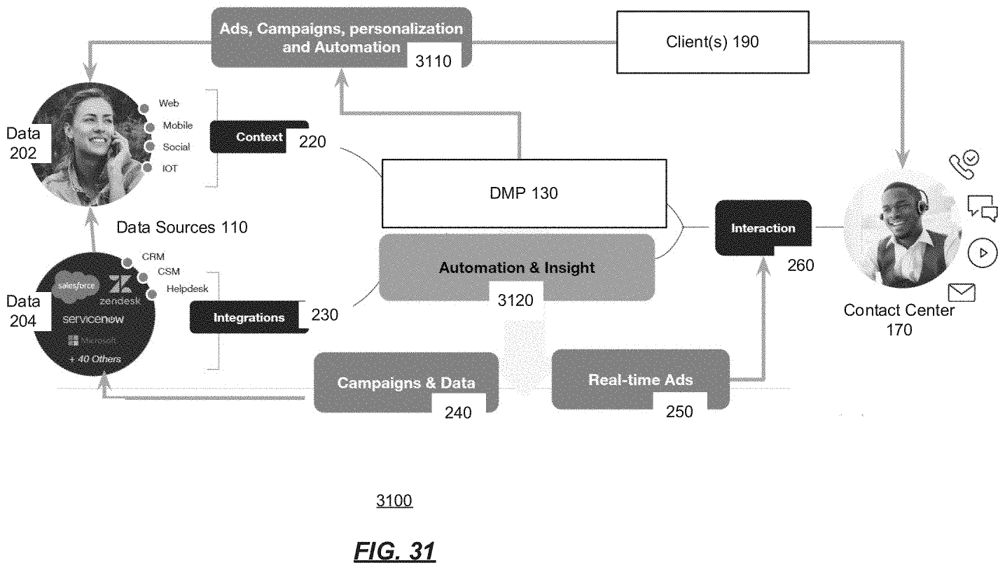

FIG. 31 is an illustration of another exemplary marketing environment 3100 using a DMP, such as the DMP 130. In the environment 3100, the data sources 110 generate and/or provide data, which are shown here as comprising, for example, customer data 202 based on web, mobile, social, and internet of things (IoT) data, conversations, postings, chats, etc. as well as customer data 204 based on customer relationship management (CRM) data, customer service management (CSM), and helpdesk relationships, interactions, etc.

The data 202 is used to provide context 220 to the DMP 130. The data 204 is used to provide integrations 230 to an automation and insight module 3120 comprised within the DMP 130 or otherwise associated with the DMP 130. The DMP 130, alone or in conjunction with the automation and insight module 3120 depending on the implementation, may process the data 202 and 204, as well as the context 220 and integrations 230 and other data described further herein.

The DMP 130, alone or in conjunction with the automation and insight module 3120 depending on the implementation, may use data, including the data 202 and 204, as well as the context 220 and integrations 230 and other data described further herein, to generate and provide real-time ads 250 and other information (e.g., marketing information) to the contact center 170 via an interaction 260 with the contact center 170. The DMP 130, alone or in conjunction with the automation and insight module 3120 depending on the implementation, may also generate campaigns and data 240 and send the campaigns and data 240 to the client(s) 190 for use in ads, campaigns, personalization, and automation that are provided to one or more of the data sources 110 (e.g., the customers 105) via, for example, web, mobile, social, or IoT products, devices, and/or services, as well as one or more clients 190 for use in affiliated contact center(s) 170.

Pillars of automation include lists/segmentation, lead nurturing, triggers, and actions. Lists/segmentation comprise the target audience (e.g., potential leads, existing prospects, or existing customers) that it is desired to build or nurture a relationship with. Lead nurturing is a method for assigning a value to a contact based on their likelihood of converting to a customer. Triggers are defined thresholds that spark a specified action from a marketing automation solution (e.g., a trigger might be used to indicate when software should send an email to a prospect and offer a demo). Actions are the moves that occur after a trigger. Continuing with the example, the action is the sending of the confirmation email after a user signs up.

Marketing automation features include email marketing, CRM integration, lead generation, campaign management, lead management and scoring, managing landing pages, social marketing, visitor tracking, content management, real-time alerts, analytics and reporting, basic organized workflow, trigger responses, customized templates, and personalized messaging, for example.

In an implementation, targeted lists are built, and the campaign is executed. Email/website behavior and activity is measured. Segmentation is performed based on activity and score leads. Qualified leads are routed to CRM. Warm leads are moved to a nurture cycle. Marketing and/or sales performance is analyzed.

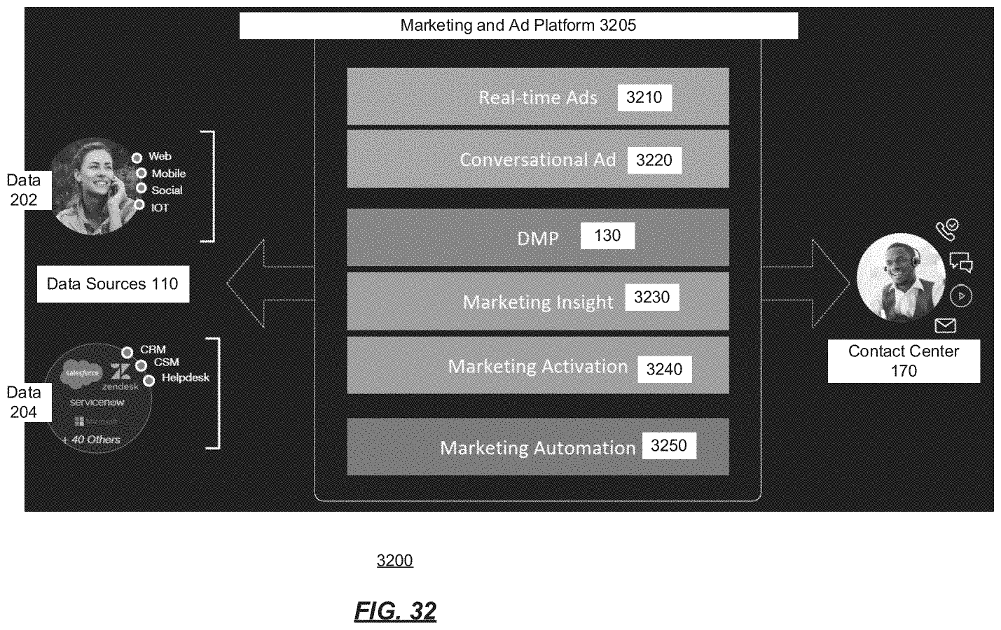

FIG. 32 is an illustration of another exemplary marketing environment 2500 using a DMP, such as the DMP 130. A marketing and ad platform 3205 comprises the DMP 130, along with modules for providing real-time ads 3210, a conversational ad 3220, marketing insight 3230, marketing activation 3240, and marketing automation 3250.

The marketing and ad platform 3205 may provide data and real-time ads 3210, a conversational ad 3220, marketing insight 3230, marketing activation 3240, and marketing automation 3250 to a contact center 170 (e.g., for use by human agents and/or virtual agents) and to customers (e.g., the data sources 110 in an implementation) via, for example, web, mobile, social, or IoT products, devices, and/or services, as well as one or more clients 190 for use in affiliated contact center(s) 170.

The marketing and ad platform 3205 may also receive data, including the data 202 and 204, as well as the context 220 and integrations 230 and other data described further herein, for use with, and to generate and provide, real-time ads 3210, a conversational ad 3220, marketing insight 3230, marketing activation 3240, and marketing automation 3250.

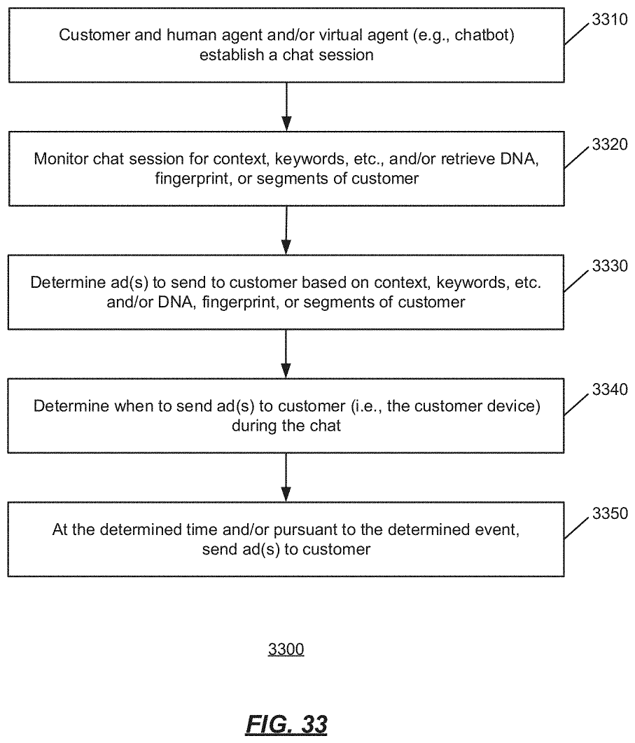

FIG. 33 is an operational flow of an implementation of a method 3300 of chat advertisement. In an implementation, one or more ads are determined and sent to the customer during a chat session between the customer and an agent or chatbot. Keyword triggering may be used. One or more aspects and/or implementations described or contemplated herein may be performed by the marketing and ad platform 3205.

At 3310, a customer and an agent, such as a human agent and/or a virtual agent (e.g., a chatbot) establish a chat session. The customer may contact the contact center with an inquiry, complaint, feedback, etc. and be put in touch with an agent of the contact center.

At 3320, during the chat session, depending on the implementation, the chat session is monitored for context, keywords, tones, emotions, aspects of demographics, aspects of psychographics, etc. Alternatively or additionally, a signature, a customer DNA, fingerprint, identifier, and/or one or more segments (as those terms are used herein) pertaining to the customer may be retrieved. The signature, customer DNA, fingerprint, identifier and/or one or more segments may be of the customer itself, or may be of one or more other customers who have been determined to have similar characteristics (e.g., personalities, demographics, psychographics, etc.) with the customer who is in the chat session with the agent.

At 3330, based on the monitoring performed at 3320, one or more ads are determined that target the customer. The ad(s) may be determined based on one or more of context, keywords, tones, emotions, aspects of demographics, aspects of psychographics, etc., a DNA, fingerprint, and/or one or more segments pertaining to the chat session and/or the customer.

At 3340, it is determined when (at what point in the chat session) to send the ad(s) to the customer. For example, it may be determined to send the ad(s) to the customer immediately, or when there is a pause or hold in the chat session of at least a predetermined duration, or after the customer's inquiry, etc. has been resolved but before the chat session terminates.

At 3350, at the determined time or point in the chat session, and/or pursuant to a predetermined event, the ad(s) are sent to the customer (e.g., to the device the customer is using for the chat session). In this manner, the customer may see and/or hear the ad(s) during the chat session.

In an implementation, keyword triggering occurs during a chat session, and an ad offer is provided to the device being used for a chat. The customer sees the add offer and selects it, leading to item browsing and shopping by the customer. Payment processing is performed, and then the chat continues.

Chatbots may be used in some implementations to interact with customers and to send ads to customers and perform other marketing and advertising aspects. Chatbots provide personalized assistance, enhance customer service, provide product recommendations, process orders, share brand and/or product updates, provide in-store assistance and navigation, offer promotions based on location, automate processes, enable discovery, and/or support storytelling, depending on the implementation.

Advertisements and sales may occur at any time during an interaction, including, but not limited to, during holding times, handling times, and/or during the conversation, depending on the implementation. Additionally or alternatively, advertisements and sales may occur at any time after an interaction (e.g., for marketing activation and campaigns). Users may be targeted on messaging apps, connected screens, and/or home assistant device, as well as phone calls.

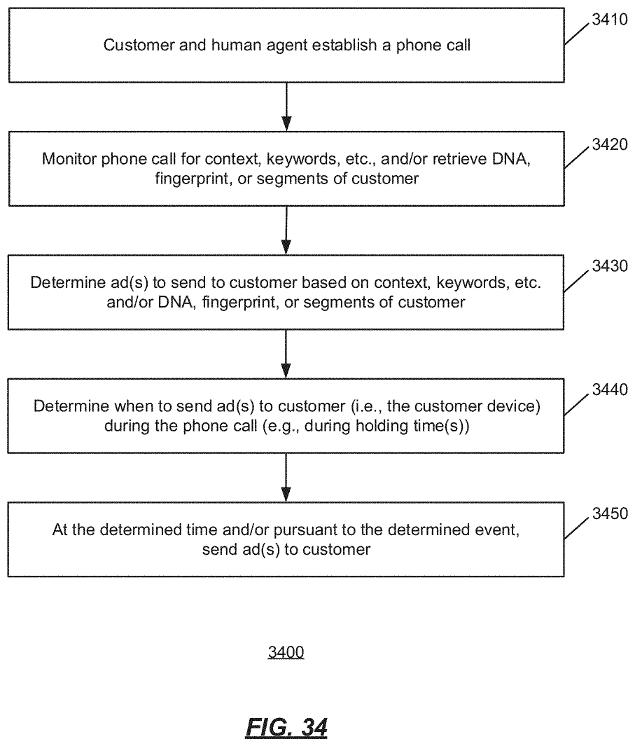

FIG. 34 is an operational flow of an implementation of a method 3400 of call advertisement. In an implementation, one or more ads may be determined and played to the customer during hold time for a call between the customer and an agent. Keyword triggering may be used. Demographics may be used. In an implementation, music (e.g., that the user likes) may also be provided to the user, alone or in addition to the ad(s). One or more aspects and/or implementations described or contemplated herein may be performed by the marketing and ad platform 3205.

At 3410, a customer and an agent, such as a human agent and/or a virtual agent (e.g., a chatbot) establish a call (e.g., an audio phone call). The customer may contact the contact center with an inquiry, complaint, feedback, etc. and be put in touch with an agent of the contact center.

At 3420, during the call, depending on the implementation, the call is monitored for context, keywords, tones, emotions, aspects of demographics, aspects of psychographics, etc. Alternatively or additionally, a DNA, fingerprint, and/or one or more segments (as those terms are used herein) pertaining to the customer may be retrieved. The DNA, fingerprint, and/or one or more segments may be of the customer itself, or may be of one or more other customers who have been determined to have similar characteristics (e.g., personalities, demographics, psychographics, etc.) with the customer who is on the call with the agent.

At 3430, based on the monitoring performed at 3420, one or more ads are determined that target the customer. The ad(s) may be determined based on one or more of context, keywords, tones, emotions, aspects of demographics, aspects of psychographics, etc., a DNA, fingerprint, and/or one or more segments pertaining to the call and/or the customer.

At 3440, it is determined when (at what point in the call) to send the ad(s) to the customer. For example, it may be determined to send the ad(s) to the customer immediately, or when there is a pause or hold in the call of at least a predetermined duration, or after the customer's inquiry, etc. has been resolved but before the call terminates.

At 3450, at the determined time or point in the call, and/or pursuant to a predetermined event, the ad(s) are sent to the customer (e.g., played to the device the customer is using for the call). In this manner, the customer hears the ad(s).

As an example, when a customer goes on hold, a virtual assistant (e.g., a virtual agent) speaks to the customer and says “hello, all agents are busy so you will be on hold for 5 minutes. What music do you want to play?” The customer makes a selection, e.g., responds: “Beyonce”. The virtual assistant responds: “great choice, say ‘change music’ at any time if you'd like to change the music.” The inventory is searched for music that matches the customer selection and that selected music is played to the customer through the customer device while the customer is on hold. Analysis and insight may subsequently be performed on the music selection and customer interaction.

Additionally or alternatively, ads and/or other music or songs may be generated and played to the customer while on hold. The ads may be based on the music selected by the customer and/or customer demographics, for example. Data and statistics based on the customer selections may be tracked, stored, maintained, and/or updated. Data and statistics may be used to generate billboards which may then be posted or otherwise stored and/or outputted.

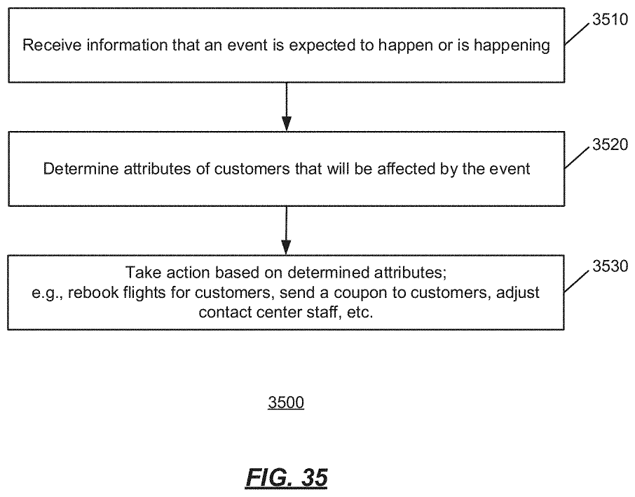

FIG. 35 is an operational flow of an implementation of a method 3500 of proactive marketing. One or more aspects and/or implementations described or contemplated herein may be performed by the marketing and ad platform 3205.

For example, a customer named John may have a record (“Record 1”) with the following segments: Record 1: Angry, John, Weekend, Storm, Cancel Flight, Los Angeles. And a customer named Mary may have a record (“Record 2”) with the following segments: Record 2: Happy, Mary, Saturday, Reserve Seat, San Francisco.

When a storm is forecast for a particular day/time, it is determined that some attributes (e.g., Angry, Storm, Cancel Flight) will be associated with the user calls around that time (predict topic, region of the country, etc.). Action is then taken based on the customers having the determined attributes.

At 3510, information may be received from one or more information sources that an event is expected to happen or is happening. The data may take any form, and be received from any source, depending on the implementation. The event may be any event, such as a weather event, a traffic event, a social event, a sporting event, a news event, etc.

At 3520, attributes of customers that may be affected, or will be affected by the event, are determined. The attributes may comprise demographic information of the customers, psychographic information of the customers, etc.

At 3530, action is taken based on the determined attributes. The action may take the form of marketing or advertising action in some implementations. For example, if there is a weather event in Seattle and it is expected that flights will be delayed, the attributes may be location, travel, personality, and frequent flyer status. For some customers, such as those whose values for those attributes “Seattle”, “flight”, “complain”, “elite status frequent flyer”, the action may include proactively changing a flight the customer is booked on, sending a voucher, coupon, or other gift to the customer, advising the customer of a possible delay, offering the customer a gift, setting up a dedicated agent in the contact center for the customer to contact or who will contact the customer, etc.

In this manner, a subset of customers (e.g., a segment of the population) are contacted that a storm (e.g., by phone, text message, email, etc.), for example, is coming, and a gift or other award or incentive is offered to each of these customers based on the customer's demographics.

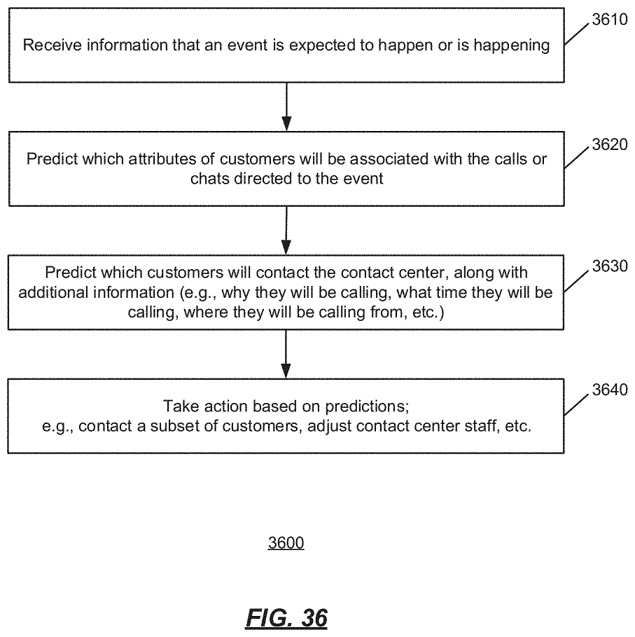

FIG. 36 is an operational flow of an implementation of a method 3600 of predictive marketing. One or more aspects and/or implementations described or contemplated herein may be performed by the marketing and ad platform 3205.

In an implementation, it may be predicted why customers are calling or will be calling, and then staff contact centers and/or call centers accordingly. For example, if a storm is in Los Angeles, and a call comes in from Los Angeles, predict it will be about the storm. If a call comes in from San Francisco, predict it will not be about the storm.

In an implementation, predict who will call based on what these individual people did in the past (e.g., John calls when there is a problem; Mary texts when there is a problem; Kate does nothing when there is a problem). This data may be used to generate demographics of who will call, who will text, who will do nothing. In this manner, it may be predicted who is calling, why they are calling, what time they are calling, where are they calling from (e.g., Mary, night, complain, from home).

A customer's record may comprise data indicating age, zip code, gender, time (morning, afternoon, night), type of mobile device used, type of operating system used, customer likes pizza, customer is a vegetarian, etc.) The data for each customer's record can be predicted based on other known data about the customer and other customers.

At 3610, information may be received from one or more information sources that an event is expected to happen or is happening. The data may take any form, and be received from any source, depending on the implementation. The event may be any event, such as a weather event, a traffic event, a social event, a sporting event, a news event, etc.

At 3620, it is predicted which attributes of customers will be associated with calls or chats directed to the event. For example, if there is a weather event in Phoenix, attributes directed to a Phoenix weather event may be predicted, such as location, flight, personality, means of contact, etc.

At 3630, it is predicted which customers will contact the contact center, along with additional information about the predicted contact, such as what time the customers will be calling or chatting, why they will be calling or chatting, where they will be calling or chatting from, what their moods and tones will be, what gift offers could satisfy the customers, etc.

At 3640, action is taken based on the predictions. For example, certain customers may be contacted regarding the event and/or a contact center can be ready to receive and handle calls from certain types of customers, along with the times the calls are predicted to be incoming to the contact center. For example, these customers may comprise a set of the customers whose demographics and/or psychographics indicate they likely will be contacting the contact center because of the event, along with how and when they will contact the contact center, and what technique (e.g., gift, empathy, etc.) is predicted to be effective in resolving the customer's complaints.

In an implementation, the staffing of a contact center may be adjusted, e.g., so that more agents are ready to receive and handle calls from customers who are predicted to call the contact center responsive to the event, so that agents are properly trained and/or prepared to receive and handle calls from customers who are predicted to call the contact center responsive to the event, etc.

Thus, for example, it may be predicted which people will call the contact center responsive to an event, such as a storm. So, for example, contact a subset of users based on demographics. In this manner, information is received that a storm is happening, a delay is then predicted, and a subset of users are contacted (e.g., the people are predicted to call the contact center) using information from their records, fingerprints, DNA, and/or segments, depending on the implementation.

FIG. 37 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 37, an exemplary system for implementing aspects described herein includes a computing device, such as computing device 3700. In its most basic configuration, computing device 3700 typically includes at least one processing unit 3702 and memory 3704. Depending on the exact configuration and type of computing device, memory 3704 may be volatile (such as random access memory (RAM)), non-volatile (such as read-only memory (ROM), flash memory, etc.), or some combination of the two. This most basic configuration is illustrated in FIG. 37 by dashed line 3706.

Computing device 3700 may have additional features/functionality. For example, computing device 3700 may include additional storage (removable and/or non-removable) including, but not limited to, magnetic or optical disks or tape. Such additional storage is illustrated in FIG. 37 by removable storage 3708 and non-removable storage 3710.

Computing device 3700 typically includes a variety of computer readable media. Computer readable media can be any available media that can be accessed by the device 3700 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 3704, removable storage 3708, and non-removable storage 3710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 3000. Any such computer storage media may be part of computing device 3700.

Computing device 3700 may contain communication connection(s) 3712 that allow the device to communicate with other devices. Computing device 3700 may also have input device(s) 3714 such as a keyboard, mouse, pen, voice input device, touch input device, etc. Output device(s) 3716 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In an implementation, a method for billboards in a data management platform (DMP) is provided. The method includes: receiving an indication from a user during an interaction between the user and an agent that the user would like to hear an offer; determining at least one offer to play to the customer; determining statistics regarding at least one of the characteristics, features, or aspects of the at least one offer that customers have indicated as liking or have acted on; determining measurements for key performance indicators (KPIs) regarding at least one of the interaction or the at least one offer, and other metrics comprising customer satisfaction (CSAT) and (average handle time (AHT); generating one or more billboards using the statistics and the measurements, wherein the billboards comprise at least one of the characteristics, features, or aspects of the at least one offer that customers have indicated as liking or have acted on; and announcing the one or more billboards to one or more of clients, contact centers, or customers.

Implementations may include some or all of the following features. The method further comprises maintaining at least one of ad providers or an ad inventory at the DMP. The method further comprises determining the at least one offer from the ad providers or ad inventory. The at least one offer comprises information about a product, music, or a phone number to call for more information or to place an order. The agent is a human agent. The agent is a virtual agent. The agent is associated with a contact center. The method further comprises requesting that the user indicate whether they would like to hear an offer. Determining the at least one offer comprises at least one of polling the customer, asking the customer one or more questions or to make one or more offer selections, viewing offer selections previously made or currently made by the customer, viewing segments or DNA or fingerprints of at least one of the customer or other customers. The method further comprises generating one or more customer portfolio management (CPM) files pertaining to the customers for one or more clients.

In an implementation, a method for billboards in a data management platform (DMP) is provided. The method includes: receiving an indication from a user during an interaction between the user and an agent that the user likes music or the user would like to listen to music; determining a music selection to play for the customer; determining statistics regarding at least one of the characteristics, features, or aspects of music that customers have indicated as liking; determining measurements for key performance indicators (KPIs) regarding at least one of the interaction or the music, and other metrics comprising customer satisfaction (CSAT) and (average handle time (AHT); generating one or more billboards using the statistics and the measurements, wherein the billboards comprise at least one of the characteristics, features, or aspects of music that customers have indicated as liking; and announcing the one or more billboards to one or more of clients, contact centers, or customers.

Implementations may include some or all of the following features. The agent is a human agent. The agent is a virtual agent. The agent is associated with a contact center. The method further comprises requesting that the user at least one of indicate whether they like music or whether they would like to listen to music. Determining the music selection comprises determining at least one of a genre, a singer, or an event based music that the customer likes. Determining the music selection comprises at least one of polling the customer, asking the customer one or more questions or to make one or more music selections, viewing music selections previously made or currently made by the customer, viewing segments or DNA or fingerprints of at least one of the customer or other customers.

In an implementation, a system for billboards is provided. The system includes: a data management platform (DMP) configured to monitor or receive data about an interaction between a customer and an agent; determine information about a customer; determine one or more ads, music, or songs to play to the customer based on the information; during a hold time in the phone call or the chat conversation, play the one or more ads, music, or songs to the customer; maintain data and statistics regarding the customer interaction with the one or more ads, music, or songs; and generate one or more billboards based on the data and statistics; and an intelligent database configured to store the data and statistics regarding the customer interaction with the one or more ads, music, or songs.

Implementations may include some or all of the following features. The interaction is a phone call or a chat conversation. The DMP receives the information about the customer from the intelligent database. The DMP is configured to retrieve the one or more ads, music, or songs to play to the customer from storage containing ads, music, or songs. The DMP is configured to announce the one or more billboards to one or more of clients, contact centers, or customers.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system for billboards, comprising:
a data management platform (DMP) configured to monitor or receive data about an interaction between a customer and an agent; determine information about the customer; determine one or more ads, music, or songs to play to the customer based on the information; during a hold time in the phone call or the chat conversation, play the one or more ads, music, or songs to the customer; maintain data and statistics regarding the customer interaction with the one or more ads, music, or songs; and generate one or more billboards based on the data and statistics; and
an intelligent database configured to store the data and statistics regarding the customer interaction with the one or more ads, music, or songs.

2. The system of claim 1, wherein the interaction is a phone call or a chat conversation.

3. The system of claim 1, wherein the DMP receives the information about the customer from the intelligent database.

4. The system of claim 1, wherein the DMP is configured to retrieve the one or more ads, music, or songs to play to the customer from storage containing ads, music, or songs.

5. The system of claim 1, wherein the DMP is configured to announce the one or more billboards to at least one client one or more of clients, contact centers, or customers.

6. The system of claim 1, wherein the DMP is configured to announce the one or more billboards to at least one contact center.

7. The system of claim 1, wherein the DMP is configured to announce the one or more billboards to at least one customer.

8. A method for billboards, the method comprising:
monitoring or receiving, at a data management platform (DMP), data about an interaction between a customer and an agent;
determining information about the customer;
determining one or more ads, music, or songs to play to the customer based on the information;
during a hold time in the phone call or the chat conversation, playing the one or more ads, music, or songs to the customer;
maintaining data and statistics regarding the customer interaction with the one or more ads, music, or songs;
generating one or more billboards based on the data and statistics; and
storing, in an intelligent database, the data and statistics regarding the customer interaction with the one or more ads, music, or songs.

9. The method of claim 8, wherein the interaction is a phone call or a chat conversation.

10. The method of claim 8, further comprising receiving the information about the customer from the intelligent database.

11. The method of claim 8, further comprising retrieving the one or more ads, music, or songs to play to the customer from storage containing ads, music, or songs.

12. The method of claim 8, further comprising announcing the one or more billboards to at least one client.

13. The method of claim 8, further comprising announcing the one or more billboards to at least one contact center.

14. The method of claim 8, further comprising announcing the one or more billboards to at least one customer.

15. A non-transitory computer-readable medium comprising instructions that, when executed by at least one processor, cause a computer system to:
monitor or receive data about an interaction between a customer and an agent;
determine information about the customer;
determine one or more ads, music, or songs to play to the customer based on the information;
during a hold time in the phone call or the chat conversation, play the one or more ads, music, or songs to the customer;
maintain data and statistics regarding the customer interaction with the one or more ads, music, or songs;
generate one or more billboards based on the data and statistics; and
store the data and statistics regarding the customer interaction with the one or more ads, music, or songs.

16. The computer-readable medium of claim 15, wherein the interaction is a phone call or a chat conversation.

17. The computer-readable medium of claim 15, further comprising instructions that, when executed by the at least one processor, cause the computer system to receive the information about the customer from an intelligent database.

18. The computer-readable medium of claim 15, further comprising instructions that, when executed by the at least one processor, cause the computer system to retrieve the one or more ads, music, or songs to play to the customer from storage containing ads, music, or songs.

19. The computer-readable medium of claim 15, further comprising instructions that, when executed by the at least one processor, cause the computer system to announce the one or more billboards to at least one client.

20. The computer-readable medium of claim 15, further comprising instructions that, when executed by the at least one processor, cause the computer system to announce the one or more billboards to at least one contact center or to at least one customer.
